(19) United States
(12) Patent Application Publication
(10) Pub. No.: US 2015/0287152 A1
(43) Pub. Date: Oct. 8, 2015

(54) System and Method for Facilitating Property Management

(71) Applicant: PropertySafe Pty Ltd., Erina, New South Wales (AU)

(72) Inventor: Philip James Oakes, New South Wales (AU)

(73) Assignee: PropertySafe Pty Ltd., Erina, New South Wales (AU)

(21) Appl. No.: 14/437,581

(22) PCT Filed: Oct. 22, 2013
(86) PCT No.: PCT/IB2013/059534

§ 371 Date: Apr. 22, 2015

(30) Foreign Application Priority Data
Oct. 22, 2012 (AU) 2012904609

(51) Int. Cl. G06Q 50/16; G06Q 10/00; G06Q 30/06

(52) U.S. Cl. CPC G06Q 50/163; G06Q 30/0611; G06Q 30/0633; G06Q 10/20

(57) ABSTRACT

The present invention relates to a system and method for facilitating property management and in particular to a system and method for facilitating maintenance of property.

A computer implemented system is provided comprising a server system arranged to communicate with remote inspector systems. The inspector systems facilitate inspection of properties. A report generator is provided to generate a report on maintenance from a repairer required for maintenance and repair of the property. Repairer modules facilitate tradesmen interacting with the system and carrying out maintenance tasks.

### CROSS REFERENCE TO RELATED APPLICATION

This application is a national stage application of International Application No. PCT/IB2013/059534, filed on Oct. 22, 2013, which claims priority to Australian patent Application No. AU 2012904609, filed Oct. 22, 2012. The above-referenced applications are hereby incorporated herein in their entireties by reference.

### FIELD OF THE INVENTION

The present invention relates to a system and method for facilitating property management, and, particularly, but not exclusively, to a system and method for facilitating management of maintenance of property.

### BACKGROUND OF THE INVENTION

Maintenance and management of property is a time consuming process which is generally carried out in an ad hoc manner. For residential property, the owner is generally responsible for ensuring that property is maintained in a good state of repair and free from any health and safety risks. Different owners have different approaches and different capabilities for maintaining properties, which leads to a relatively haphazard approach to property maintenance, and variation in the quality of maintained properties across the residential market. Properties can be poorly maintained and health and safety risks may exist that need to be dealt with. In some cases the owner does not know about repair requirements or health and safety risks, or does not have the skills to identify them.

This can be particularly the case in the investment (rental) market, where the landlord (owner) has responsibility to provide a safe environment for tenants. Often, the property owner will place his property under the professional management of an agent and rely upon their skills to ensure the property is well maintained and safe for the tenant. Agents endeavour to fulfil this task but rarely have the skills to adequately deal with it. This can mean that the tenant is exposed to a health and safety risk. If an accident occurs, both the agent and landlord (owner) are exposed to legal and financial penalties. The agent and particularly the owner, therefore carry significant liability. To mitigate this risk, it is important that the property is adequately maintained. Unfortunately, it is not always the case that adequate maintenance exists.

Similar risks and liabilities pertain to the owner-occupier market. It is the responsibility of every property owner to provide a safe environment for their family, friends and visitors. Every owner wants to know that their property is safe for their family and visitors. Poor maintenance can expose the owner to legal and financial risk. Statistics regarding injuries around the home show that in New South Wales, Australia, 1,300 children are hospitalised each week and 1 in 3 seniors over the age of 65 have falls (in the home) each year. It is estimated that 60 percent of these injuries from falls are preventable. Again, however, there is no convenient means, and only an ad hoc approach, to ensure adequate maintenance of residential property.

Another problem is there is no convenient and consistent means for reporting property maintenance issues. A maintenance issue may be reported by a tenant, for example, by telephone. The property administrator or owner would then need to confirm the nature of the maintenance issue and what might be required to fix it. This can require the administrator/owner attending at the property to view the maintenance issue, and then obtaining quotes from repairers using conventional means e.g. telephone, internet, e-mail. All this is extremely time consuming and inefficient.

### SUMMARY OF INVENTION

In accordance with a first aspect, the present invention provides a system for facilitating maintenance of property, comprising a processor arranged to receive customer orders for property inspection, to communicate with inspector systems and initiate a property inspection, and to receive from the inspection system inspection data, and a report generator arranged to generate a report on maintenance and repair required for maintenance and repair of the property. In an embodiment, the system enables customer access to the maintenance and repair report. The system may enable Web access, for example.

In an embodiment, the system comprises a repairer interface arranged to obtain quote data from repairers. In an embodiment, the customer has access to the quote data, and the system is arranged to receive orders from the customers and generate orders for the repairers to make repairs to the property in accordance with repair items listed on the report.

In an embodiment, a repairer process is provided, which may be implemented by software/hardware on a repairer computer device, which may be a mobile device, such as a smart phone or tablet. The repairer process is arranged to facilitate the provision of quote data to the repairer interface of the system. There are some systems available which enable a repairer to input quote information to a property management system. These systems often require a repairer to fill in many fields in a computing system. Tradesmen do not often have the time or the will to fill in complex fields on computer forms.

In an embodiment, the repairer process enables a repairer to capture their typical format which they provide quote data in. For example, if the repairer is used to providing a written quote format, the repairer process can capture this. It may, for example, capture it by capturing an image of their usual filled out quote form, and forwarding that image to the system.

In an embodiment, the system comprises a database arranged to store report data and repair data. In an embodiment, the database is updatable with maintenance and repair data.

In an embodiment, the system comprises an inspection apparatus which, in an embodiment may comprise an inspection module arranged to facilitate property inspections. In one embodiment, the inspection apparatus/module may be implemented by a remote field device. It may be an application on a tablet device or a mobile telephone device in an embodiment. The inspection module may guide the inspector through information required to facilitate the inspection, and may request the inspector to input certain types of inspection data. It also may enable uploading of images, such as photographs taken by the field device.

In an embodiment, the system comprises a reminder arrangement arranged to remind the customer based on the report of what items are outstanding to be dealt with. The reminder arrangement may also be enabled to remind the customer when inspections are due. The reminder arrangement may be a reminder module arranged to auto-generate the reminders.

In an embodiment, where the database is arranged to store or report data and repair data, the database is arranged to provide a history log of events. This may advantageously serve as an evidential trail, which may be able to be incorporated into other management systems.

The system in accordance with an embodiment of the invention preferably has the advantage that it provides a listed system for management of property maintenance. In embodiments, it provides the customer with reminders so that e.g. an owner may be kept up to date with property inspection requirements. It puts the customer in touch with repairers and facilitates dealing with items that require repair. It also facilitates the inspection process by providing a module which guides the inspector through the inspection process.

In accordance with a second aspect, the present invention provides a method of facilitating maintenance of property, comprising steps of receiving customer orders for property inspection, communicating the orders with inspector systems to initiate a property inspection, and receiving from the inspector system inspection data, generating a report based on the inspection data, the report including details of maintenance and repair required for maintenance and repair of property.

In accordance with a third aspect, the present invention provides a computer program, comprising instructions for controlling a computer to implement a system in accordance with the first aspect of the invention.

In accordance with a fourth aspect, the present invention provides a computer readable medium, comprising a computer program in accordance with the third aspect of the invention.

In accordance with a fifth aspect, the present invention provides a data signal, comprising a computer program in accordance with the third aspect of the invention.

In the above aspects of the invention, in one embodiment, the inspection module provides a comprehensive menu guiding the inspector through information required to facilitate the inspection and prompting inputs from the inspector, including prompting inputs by way of menu listings. In another embodiment of the invention, a simple maintenance module/application is provided which may be used by any person e.g. a tenant, landlord (owner) or property manager (e.g. real estate agent)to input maintenance issues that may be used to alert property administrators/managers/owners about issues requiring repair. Such a maintenance application may be used together with the system of the above aspects of the invention, or may be used separately as a simple and convenient means for reporting maintenance issues.

In accordance with a sixth aspect, the present invention provides an apparatus for logging a property maintenance issue, comprising a processor and a user interface, and a maintenance process arranged to obtain maintenance information about a property maintenance issue, and communicate the maintenance information to a property operative.

The property operative may be a property repairer, an administrator of the property e.g. owner, property manager or anyone else who may need to be notified about a maintenance issue arising at a property.

In an embodiment, the maintenance information may comprise an image of the maintenance captured by the apparatus. In an embodiment, the maintenance information may comprise textual information entered via the user interface.

In an embodiment, the maintenance process is arranged to produce a maintenance issue document that can be forwarded to a repairer, for the repairer to provide a quote on repair associated with the maintenance issue.

In an embodiment, the apparatus may be a portable device, such as a smart phone, tablet computer or other portable device. In an embodiment, the maintenance process may be an “App” arranged to be downloaded to the device.

In an embodiment, the apparatus may work with the system of previous aspects of the invention to enable a person to report maintenance issues to the system. The apparatus may also work independently, to report maintenance issues to property operatives or any other system.

Property may include residential and commercial property, but may also include other property such as cars, boats, or any other property.

In an embodiment, the maintenance process is arranged to communicate with a remote computing device, such as a server, to communicate the maintenance information. A server maintenance process may be communicated with by the maintenance process to facilitate reporting of the maintenance information. It may facilitate generation of a “maintenance issue document”, for example. The remote computing device may be part of the system described in above aspects of the invention, or may be separate.

In accordance with a seventh aspect, the present invention provides a method of logging a property maintenance issue, comprising the steps of providing a mobile device user with the maintenance process of the sixth aspect of the invention.

In accordance with an eighth aspect, the present invention provides a computer program, comprising instructions for controlling a computer to implement an apparatus in accordance with the sixth aspect of the invention.

In accordance with a ninth aspect, the present invention provides a computer readable medium, comprising a computer program in accordance with the eighth aspect of the invention.

In accordance with a tenth aspect, the present invention provides a data signal, comprising a computer program in accordance with the eighth aspect of the invention.

The computer program may be an “App” which is downloadable to any computing device, including smart phones, tablet computers and any other computing device.

### BRIEF DESCRIPTION OF THE FIGURES

Features and advantages of the present invention will become apparent from the following description of embodiments thereof, by way of example only, with reference to the accompanying drawings, in which;

FIG. 1 is a schematic diagram of a system in accordance with an embodiment of the present invention;

FIG. 2 is a further schematic diagram of the system of FIG. 1 showing functional components in more detail, and

FIGS. 3 to 9 are flow diagrams illustrating operation of a system in accordance with an embodiment of the present invention.

FIGS. 10 to 19 are representations of interfaces generated by an inspection module of the system, for use by an inspector;

FIGS. 20 and 21 are representations of maintenance issue information forms that may be generated by the system;

FIGS. 22 through 26 are example screen shots which may be produced on a repairer device incorporating a repairer process in accordance with an embodiment of the present invention, and a screenshot (FIG. 26) appearing on a system interface in response to the repairer process;

FIGS. 27 to 38 are sample screenshots showing example operation of a system in accordance with an embodiment of the present invention, dealing with a maintenance issue;

FIG. 39 is a schematic block diagram of an apparatus for logging a property maintenance issue, in accordance with an embodiment of the present invention;

FIG. 40 is a more detailed view of an apparatus for logging a property maintenance issue, in accordance with an embodiment of the invention;

FIG. 41 is a sample of a “maintenance issue” document generated by the embodiment of FIGS. 39 and 40;

FIG. 42 is a sample screenshot of a screen which may be produced by the logging apparatus of FIGS. 39 to 41.

### DETAILED DESCRIPTION OF EMBODIMENTS OF THE INVENTION

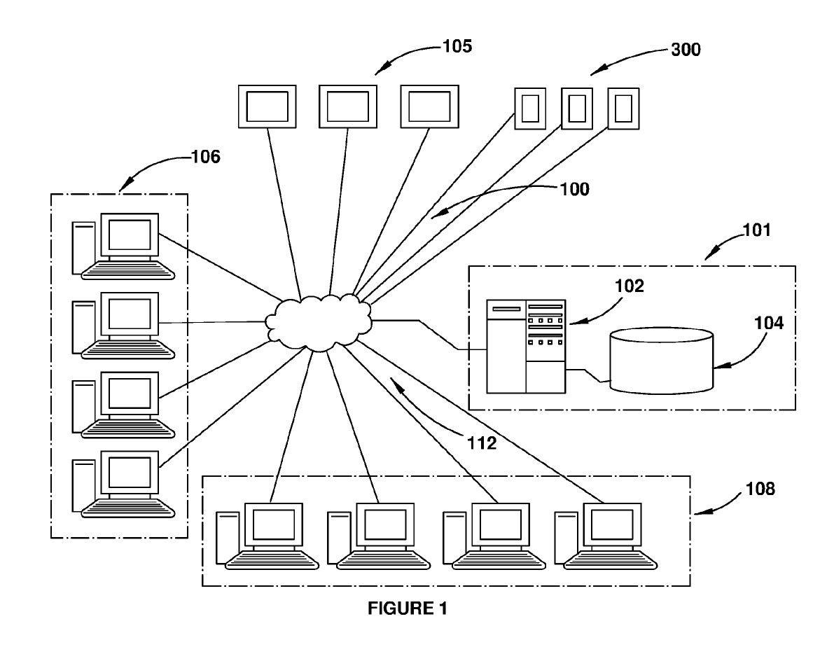

FIG. 1 illustrates a system, generally designated by reference numeral 101 for facilitating management of properties, in particular for facilitating management of maintenance of properties. In this example, the system comprises a server 102 and database 104. The system 101 is arranged to receive orders for inspection from customers, via customer systems 108. The system 101 is then arranged to generate inspection orders and provide them to inspector systems 106 so that inspectors can be instructed to attend a property to make an inspection. In this embodiment, individual inspectors may have field inspection devices 105 which enable them to attend a property and input inspection data. The inspection data is returned to the system 101 (it may be returned via inspector computing systems 106, or it may be returned directly from the remote field device 105). The system 101 then generates an inspection report which can be accessed by the customer computers 108. In another embodiment, the remote field device 105 may generate a report. In yet another embodiment, the system 101 and remote field device 105 may both partly generate the report to complete a report.

The system also enables instruction of operatives, such as repairers, via operative's computer systems, to provide quotes for repair. In response to customers 108 indicating a go-ahead with an operation, the system also instructs repairers 106 to carry out the repair. Any repairs carried out are used to generate repair data to update the database 104 with the status of maintenance of the property. The system 101 also sends reminders to customers and repairers regarding action items that have been done or need to be done. Reminders may also be sent regarding when inspections are due.

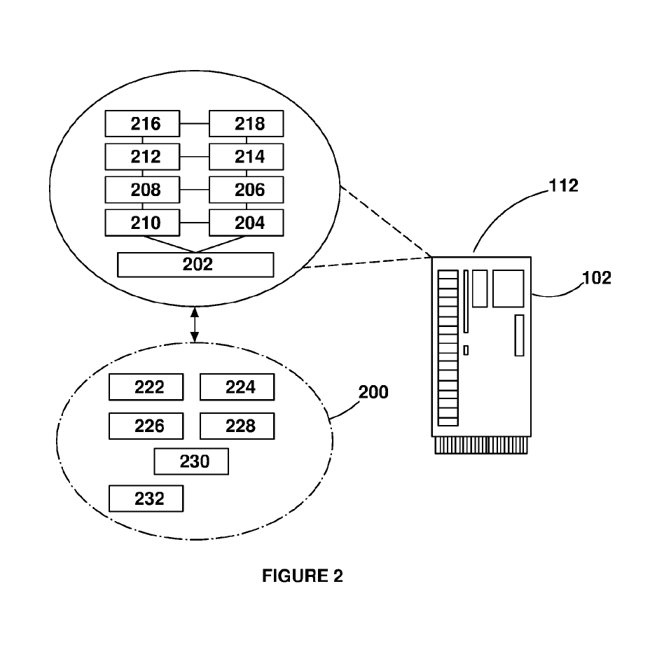

A more detailed schematic diagram of the server 102 is provided in FIG. 2. The server 102 comprises a processor 202, Read Only Memory (ROM) 204, Random Access Memory (RAM) 206 and input/output devices such as disk drives 208 (or alternatively or additionally solid state memory could equally be utilised), keyboard 210, mouse 212, display 214, printer 216 and communications device(s) 218. The communications device(s) 218 enables communications via communication network 112 (FIG. 1). The communications network 112 may be any appropriate communications network, that is likely to utilise a number of different communications infrastructures. Infrastructure may comprise computer network, telephone line, wireless network, a combination of one or more of these or any other type of communications network. In this embodiment the server 102 is arranged to serve webpages over the Internet to customer 108 and operative 106, 105 devices. In this embodiment the system is implemented via client/server (102) architecture.

Disk drives 208 may include any suitable storage media such as, for example, floppy disk drives, hard drives, CD ROM drives or magnetic tape drives. The server 102 may use a single disk drive 208 or multiple disk drives. In addition to the hardware, the server 102 also comprises operating systems such as Windows™ or Unix™. The operating system provides an environment for executing software applications.

In this embodiment, the functionality implemented by the hardware with software applications comprises a number of functional modules 200 arranged to implement the property maintenance/management system. The term “module” as used herein relates to a functional module which may be implemented in either software or hardware that can operate either independently of one another or in combination with other modules to provide the functionality of the system. It should be understood that the defined functional modules may not be implemented as separate software/hardware modules, sub-routines or the like. Although they could be separate, they may be integrated in a holistic software/hardware system.

In this embodiment, the functional modules comprise a customer interface module 222; inspector interface module 224; inspection module 226; notification and repair module 228; quotation module 230 and analysis module 232. The functionality of these modules will be described in detail in the following description.

Referring again to FIG. 1, system 101 interacts via communications networks 102 with customer devices 108 and operative devices 106/105.

The customer devices 108 may be associated with various customer types for the system. These customer types may include Agents e.g. real estate agents who are responsible for management of properties, such as management of rental properties. Customer types may include property owners, such as landlords of rental properties or owner-occupiers. The customer types may also include tenants of rental properties who have input into the system. The customer devices may comprise any device which includes hardware/software providing the functionality to interact with the system 101. They may include PCs (as illustrated) or they may include any other device, such as laptops, tablet computers, mobile devices or any other type of device. In this embodiment, they are provided with appropriate operating systems and browser software to allow them to receive webpages served by server 102, and interact with the webpages.

Operatives may include inspectors and inspection companies arranged to carry out property inspection. These may include any type of inspector, such as pest inspectors, electrical inspectors, water maintenance engineers and any other type of inspector. Operatives may also include repairers, such as electricians, plumbers, builders and any other type of repairer.

The devices 106 may be PCs as shown or any other device that can interact with system 101, such as mobile devices (tablets, phones), laptops or any other device.

Inspectors may also have access to field devices 105, which enable them to enter data remotely when they are inspecting a property. The field devices may include bespoke hardware or generally available hardware, such as tablet computers, programmed with appropriate applications to facilitate inspection. Field devices 105 may include appropriate functionality to interact with the inspector interface module and inspection module of system 101. In an embodiment all or part of the inspector module may be hosted by the field device 105.

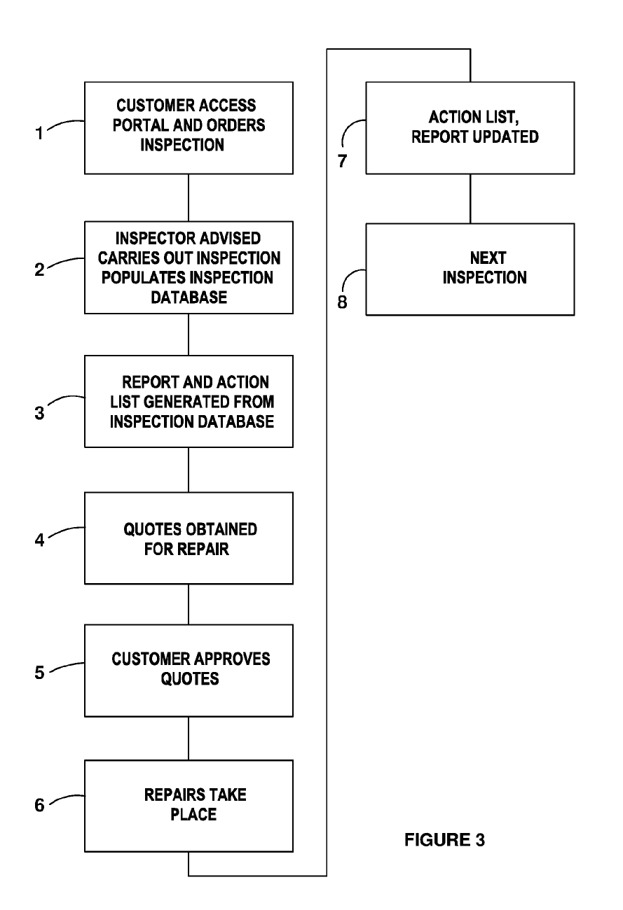

A basic process for property management implemented by the system 101 will now be described with reference to FIG. 3.

Server 102 serves webpages to customer devices 108, the webpages implementing a portal to the system 101. The customer accesses the portal (step 1, FIG. 3). The customer may be, as discussed above, an agent, an owner or a tenant. The portal includes an interface which enables the customer to enter their details (e.g. property details) and view data relating to their property. In this example, the portal provides an order form for the customer to order an inspection of their property. The system 101 receives the inspection order, and selects (step 2) an inspector to go out and inspect the property. The system 101 sends an alert to the inspector device 106 (or 105) via the telecommunications network 112. The alert may be sent by email, SMS or any other way. Alternatively, server 102 may serve webpages to an inspector device 106 and when the inspector views the webpages they will see that there is an inspection for them to carry out. The inspector acknowledges the inspection request and proceeds to inspect the property.

Using their field device 105 the inspector attends the property and carries out the inspection. The field device 105 supports part or all of an inspection module, or communicates remotely with server 102 which supports the inspection module (or part of it). As will be described in more detail later, the inspection module provides an interface which leads the property inspector through the inspection and enables him to enter inspection data on the status of items inspected.

Via the field device 105, an inspection database is populated with inspection data on the property. At step 3, the system 102 then generates a report which can be accessed by the customer via their devices 108 and also an action list (which may be included and/or be separate from the report). The action list includes a list of items that require maintenance/repair.

If repair is required, the system 102, in one alternative, automatically sends the action list to repairer devices 106 so that repairers can quote on carrying out repairs. Quotes are returned to the system 102.

In an alternative embodiment, the customer may manually request repair quotes and the system may then obtain the quotes.

At step 5, the customer approves the quote and system 102 advises the repairers to proceed.

At step 6, repairs take place and the repairer communicates repair data to the system 102.

At step 7 the action list and report are updated by the system 102 and the client/customer can access to see that the repairs have taken place.

At step 8, the system may remind the customer that an inspection is required and/or remind the customer that repairs need to be carried out.

The database 104 is continuously being amended and populated with inspection data and repair data. As well as providing an up to date log of maintenance activities, this also provides evidence of maintenance, should it be required (e.g. for legal proceedings).

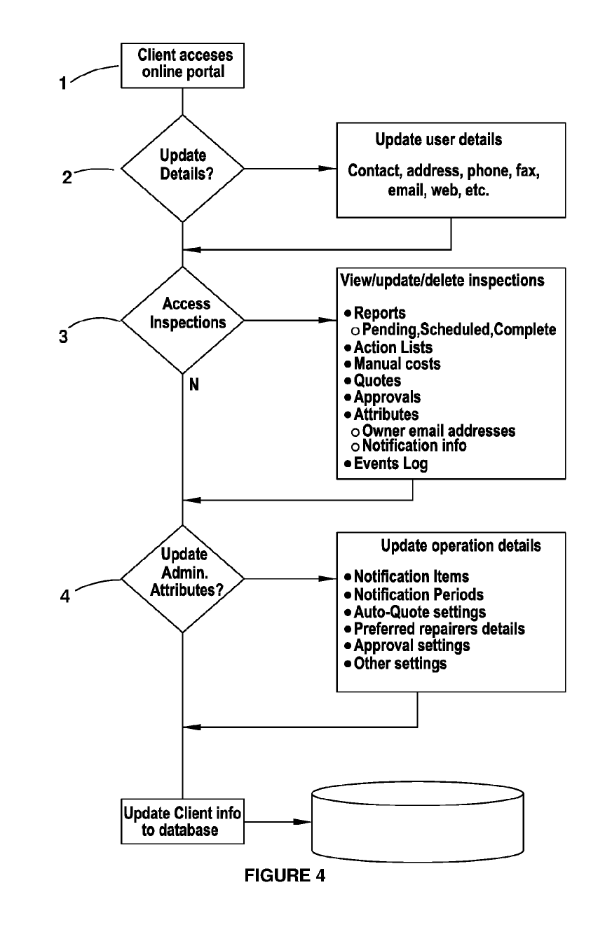

FIG. 4 is a flow diagram which shows more detail of some operations of the customer interface module 224. At Step 1, the customer (agent, owner or tenant) accesses the online portal generated by the system 101. They may update their details (e.g. contact, address, phone, fax, email, etc., property address details etc.) (Step 2).

The system 101 generates an Inspections Interface via the portal. Via this interface a client may review property reports and determine whether they are Pending, Scheduled or Complete. They may also view action lists (e.g. of repairs that are required), Quotes, Approvals, etc. They may also view an events log which may provide a list of events that have occurred at the property (e.g. repairs) as well as reminders as to when actions may be required e.g. next inspection. The client is able to access the inspections interface at Step 3.

The client is also able to access an Administration Panel Interface (Step 4) where they can view and update operational details. For example, they can determine whether to select (Auto-Quote) functionality. If Auto-Quote is selected, then when report determines that items require repair, the system 101 automatically notifies authorised repairers and requests quotes.

The functionality of the customer interface module therefore enables the user to interact with the system 101 and update details, order inspections, and adjust various settings. Information that can be accessed and amended includes, but is not limited to:
I. The status of the order—pending, scheduled (including date/time), completed;
II. Completed reports available for uploading;
III. Recommended action list for each property;
IV. An administration panel whereby they can:
   a. add details of their preferred tradesmen/repairers to the automatic quote system;
   b. view and/or select quotes;
   c. if auto-quoting is not selected, add quotes to the action list items;
   d. close out an item as completed;
   e. set the timeframe for reminders to be automatically dispatched.
V. See and import a log of events for evidential purposes.

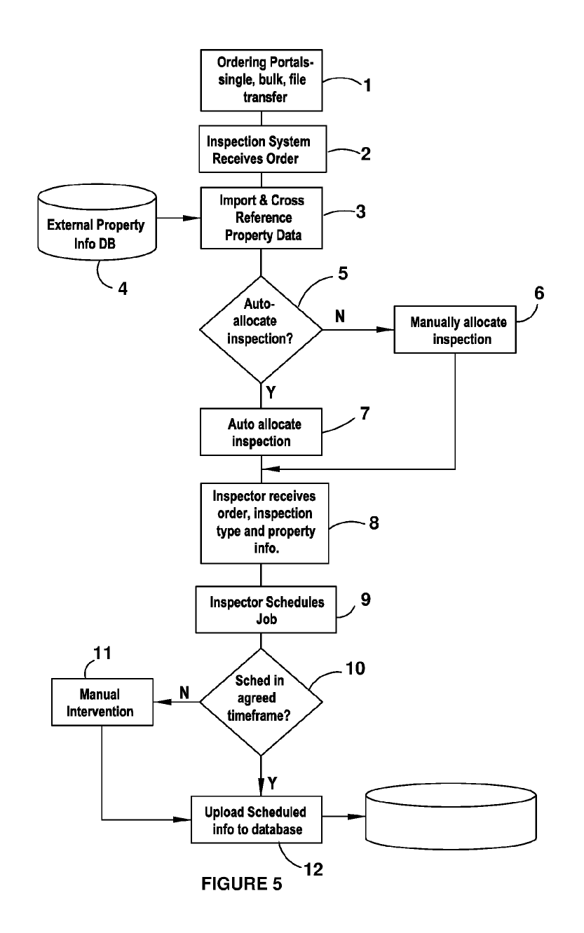

FIG. 5 is a flow diagram illustrating some operations of an inspection interface module 224 of the system 101.

Inspection orders from customers can be received via numerous methods of information transfer. These include but are not limited to:
I. Manual entry into ordering screens via the customer portal (customer interface module);
II. Bulk ordering via uploading spread sheets in a CSV format;
III. Bulk ordering via uploading a XML file or similar generated by a customer's property management system;
IV. Bulk ordering via a XML or similar transfer generated by the customer's system directly into the system.

The ordering process contains relevant details about the inspection property including a property identifier, size of the property, access information, resident names and contact details, required timeframe etc.

When the order is received the system 101 automatically allocates the job to the most appropriate field inspector based upon regions and skills. If required, manual override or allocation is available. The system can allocate the jobs to either internal field representatives or third party inspectors/companies.

When the order is dispatched, the system 101 will automatically facilitate the transfer of all the relevant information required to complete the inspection.

On receipt of the order the inspector or the system will acknowledge receipt of the order and schedule the inspection.

The inspection company will be able to view and monitor all orders and scheduled inspections via the web-enabled system, therefore ensuring that all inspections are carried out within the required timeframes.

The system may use a separate inspection company or the inspection company may administer the system. If a separate inspection company is used, the information will be uploaded from system 101 to the inspection company as above. Referring to FIG. 1, where the inspection company is separate from a system 101 the devices 106 can be used to upload the information to the inspection company devices 105 of the field inspectors.

Referring again to FIG. 5, Step 1 illustrates inspection ordering. At Step 2, the inspection system 101 receives the order and either instructs an inspector directly or via separate inspection company, via devices 106/105. See Steps 5, 6, 7. The system 101 may auto-allocate the inspection (Steps 5 and 7) or manually allocate the inspection (Step 6). Note also the intervening Step of ensuring that the property data is imported into the system (Step 3) from external database (Step 4) if the database is available, or otherwise property data may be imported manually.

At Step 8 the field inspector receives the order and property information. They schedule the job (Step 9) and agree to perform the job in an appropriate time period. The timeframe for inspection is uploaded to the database (Steps 10, 11 and 12).

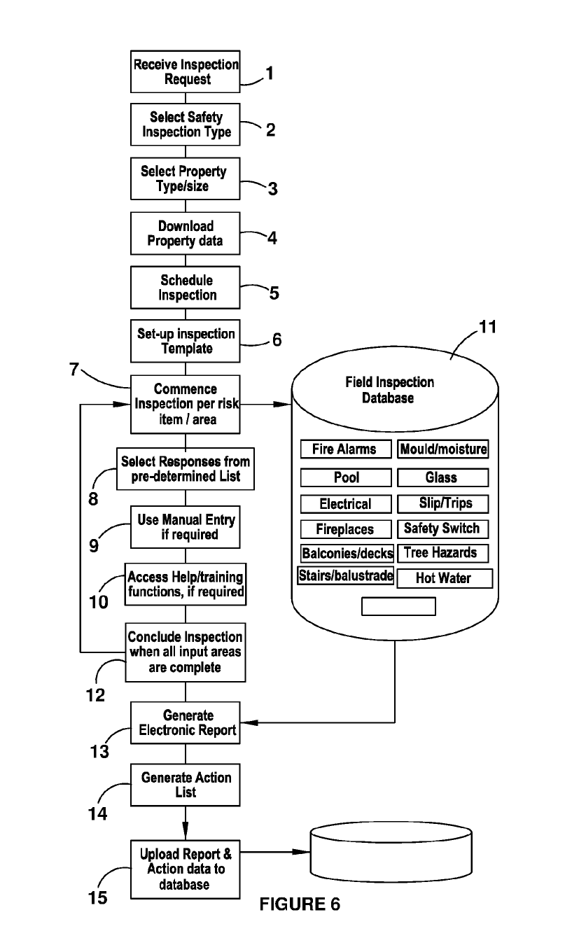

FIG. 6 is a flow diagram showing some functionality of the inspection module 226. The inspection module. The inspection module may be resident on the system and accessible by field devices 105 e.g. via the Web. In other embodiments, the module 226 may be partly on the system 101 and partly on the field device 105. In some embodiments, the inspection module 226 may be mainly resident on device 105 and provide data to the system 101 for populating the Field Inspection Database 101. In an embodiment, the inspection module 226 may partly comprise an application on a tablet device or smartphone 105 which implements the field inspection device 105.

The inspection module 226 facilitates inspections for safety hazard/risk management issues for residential properties in particular. It may be arranged to facilitate any type of inspection however.

In this embodiment, the inspection module 226 is arranged to facilitate examination by the inspector of items in a property which include items where failure could result in a hazardous issue. Such items include but are not limited to:

Smoke alarms and fire safety items;

External Balconies, decks and stairs;

Internal stairs and balustrades;

Pool fencing and gates;

Window height hazards;

Electrical hazards;

Fireplaces and fixed heaters;

Glass doors and panels;

Electric safety switch;

Gas leakage;

Slip and trip hazards;

Overhanging tree hazards;

Moisture and mould detection;

Hot water hazards.

Via the Inspection Module 226, the hand held field computing device 105 provides pre-determined responses to safety hazards discovered plus the ability to manually input additional comments as required.

The device 105 enables the inspector to answer required questions in relation to specific areas of the property plus the ability to incorporate photos/images of a safety hazard directly into the response for that question.

At the completion of the inspection a report can be immediately generated, with images incorporated, and dispatched electronically to the main data system, the client or the head office.

The report may be generated by the inspection module 226. It may be generated at the field device and transmitted to the system 101; it may be generated by the system 101, or it may be generated partly by the field device 105 and system 101.

An example report is provided at the end of this document, as an Appendix. This report is an example only and the report can be varied in content and layout in other embodiments. Trade marks such as “PropertySafe™” used in the report are brand names only and any other trade mark could be utilised.

Referring to FIG. 6, this shows an inspection process using the field device 105 and inspection module 116. At Step 1, the inspection request is received. Inspection type is selected at Step 2. At Step 3 the property type and size is selected and the property data is downloaded (Step 4). The inspection is scheduled (Step 5).

The inspector attends the property and sets up the inspection template on the inspection module 226 (Step 6).

The inspection is commenced (Step 7) and responses are input from a predetermined list of responses relating to the inspection item (Step 8). Where a selectable response is not available or where additional responses are required, manual entry may be made (Step 9).

The inspection action module also provides Help and Training functions which may be accessed if required (Step 10).

The field inspection database is populated with data from the inspection (Step 11). The inspection is concluded when all input areas are complete (Step 12). The electronic report is generated from the field inspection database (Step 13). An Action List is generated (Step 14) including action items, such as repairs that need to be carried out (Step 14). The report and action data are uploaded to the system database 104 (Step 15).

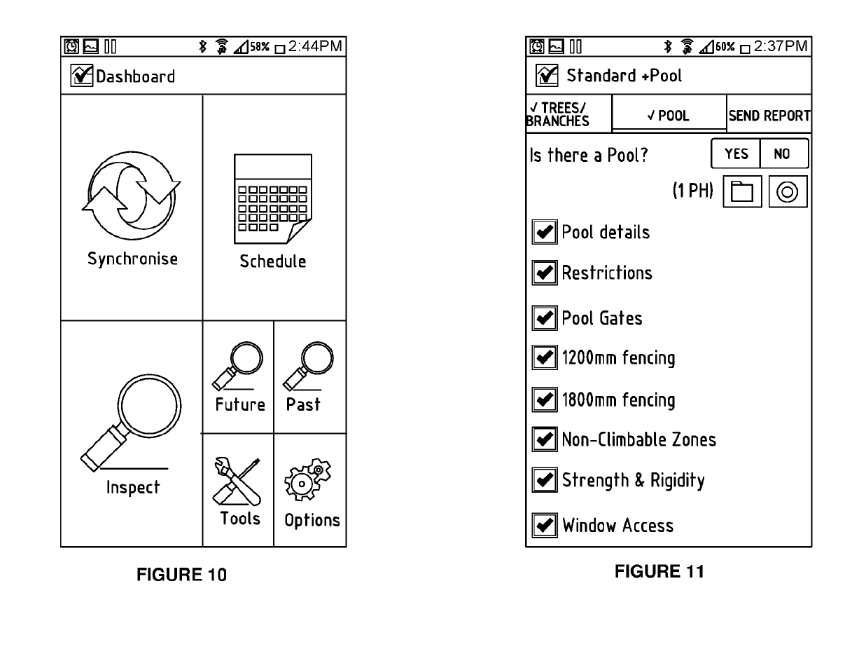

Some examples of the inspection module interface on the field device 105 are shown in FIGS. 10 to 19, for one embodiment. This embodiment may be applied in a smart phone interface, for example.

FIG. 10 shows a Dashboard that enables the inspector to navigate the module.

FIG. 11 shows an example screen where the inspector has “checked” various requirements relating to a pool associated with the property.

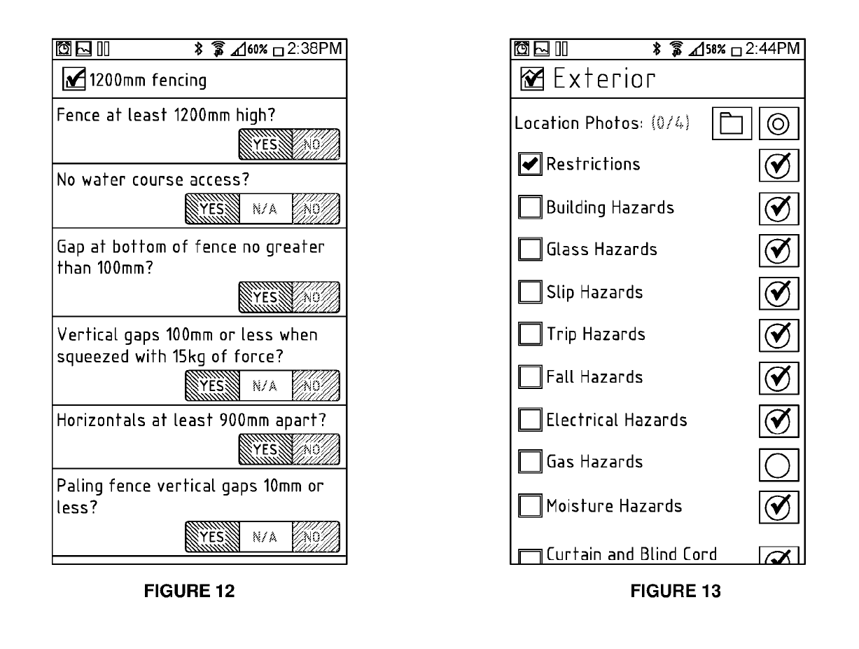

FIG. 12 shows that the inspector has inspected various items relating to a 1200 mm fence.

FIG. 13 relates to various checks the inspector is to make on items relating to the exterior of the house.

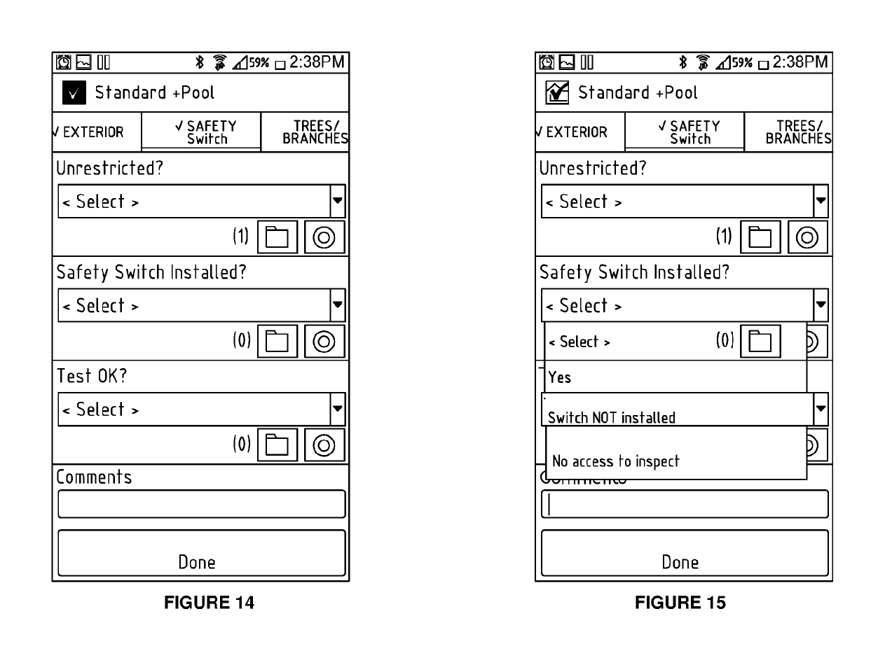

FIG. 14 relates to a menu relating to checking of an electrical safety switch.

FIG. 15 shows a drop-down menu giving selections that the inspector can enter in relation to the safety switch.

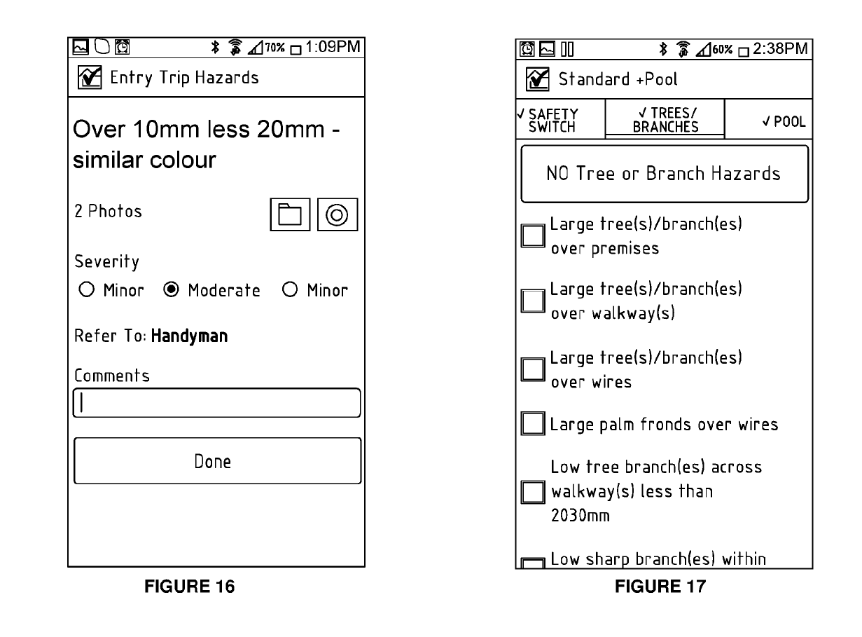

FIG. 16 shows a menu that enables the inspector to log a hazard, in this case an entry trip hazard, determine that it is “moderate” in this case, and refer it to a repairer, in this case, a Handyman.

FIG. 17 shows a menu that enables an inspector to check items regarding “tree or branch hazards”. In this case there aren't any.

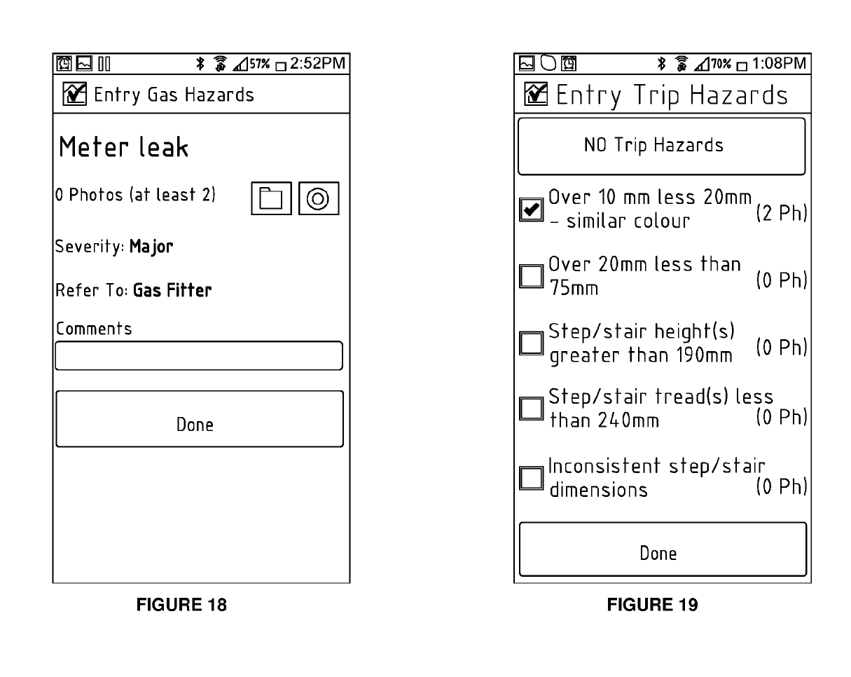

FIG. 18 shows a menu which enables an inspector to enter a gas meter leak item, in this case it is a “major” leak and is referred to a “Gas Fitter” for repair.

FIG. 19 shows an Entry Trip Hazard menu. In this case, the inspector has checked “over 10 mm, less 20 mm” and the hazard is a similar colour to the surrounding floor. The inspector has taken two photos (“2 Ph”).

FIGS. 10 to 19 are just some samples of interfaces provided by the inspection module of this embodiment. Many more interfaces may be provided to enable the inspector to carry out the inspection and produce and enable the system to produce the Risk Management Report (see the Appendix).

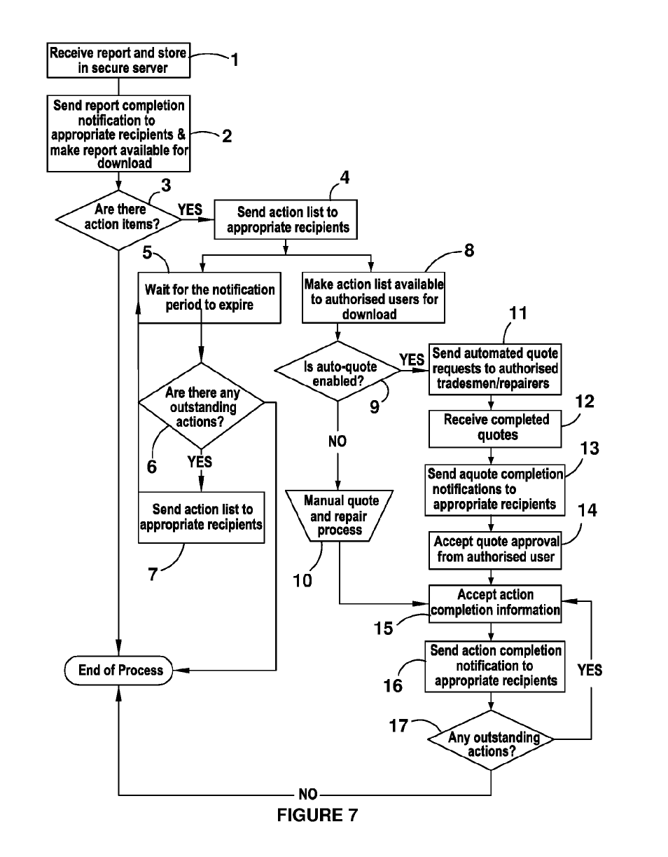

FIG. 7 is a flow diagram illustrating some operations of the notification repair module 228 of the system 101.

As discussed above, the system will generate an “Action List” (report summary) of health and safety items that need to be addressed by the property owner in order for the property to be deemed safe. If the client is an agent or representative of the property, they can download a version of this list so that it can be mail merged with contact address details and sent to the owner requesting action. Alternatively they can enable the system so that it sends the initial notification about the “Action List” plus a copy of the report.

If auto-quote option is selected by the client, it can automatically send out quote requests for the items listed in the action list to authorised tradesmen/repairers. The system can receive the completed quotes, pass them onto the owner for approval and record the relevant dates of each step.

If the auto-quote option is selected the customer will also get a web-enabled login so that they can view the quotes and approve one online.

The system will automatically send out notifications to the customers at selected intervals reminding them that there are still outstanding items that should be addressed.

The system retains a log (events list) of all the actions that have occurred so that the client can prove what actions they took or initiated. The list is available to be imported into the client's management system if necessary.

The system can automatically schedule subsequent inspections to the properties and create reminder alerts as required.

The existing data can be used to compare current inspections or previous inspections.

Referring to FIG. 7, reports, with any action items, are provided to the customers via the system 101 and their devices 108 (Steps 1, 2 and 3). If there are action items, the action list is sent to the appropriate recipients (Step 4).

In some embodiments, the system may then rely on the customers to carry out the actions and notify the system. For such a process, the system may send reminders of outstanding actions (Steps 5, 6 and 7). The system stops sending reminders when it has been confirmed by the customer that all action items have been dealt with. In this process, the customer deals with the action items themselves and does not involve the system in dealing with the action items.

In an alternative process facilitated by the system, the system is arranged to facilitate quotes by authorised tradesmen and/or repairers (Steps 8, 9, 10). If the “auto-quote” process is enabled, then an automated quote request is sent to authorised repairers (Step 11). Completed quotes are received by the system (Step 12) and the quotes are automatically made available to the customers (Step 13). The customer may approve the quote(s) with the system (Step 14).

Alternatively, if auto-quote is not enabled, the process enters a manual quote and repair process (Step 10) which may be dealt with by the customer.

Whichever process is used (manual quote or auto-quote) the system is then updated by the customer confirming that action items have been completed (Step 15). Customers are notified of action completion (Step 16) and reminded of any outstanding actions (Step 17).

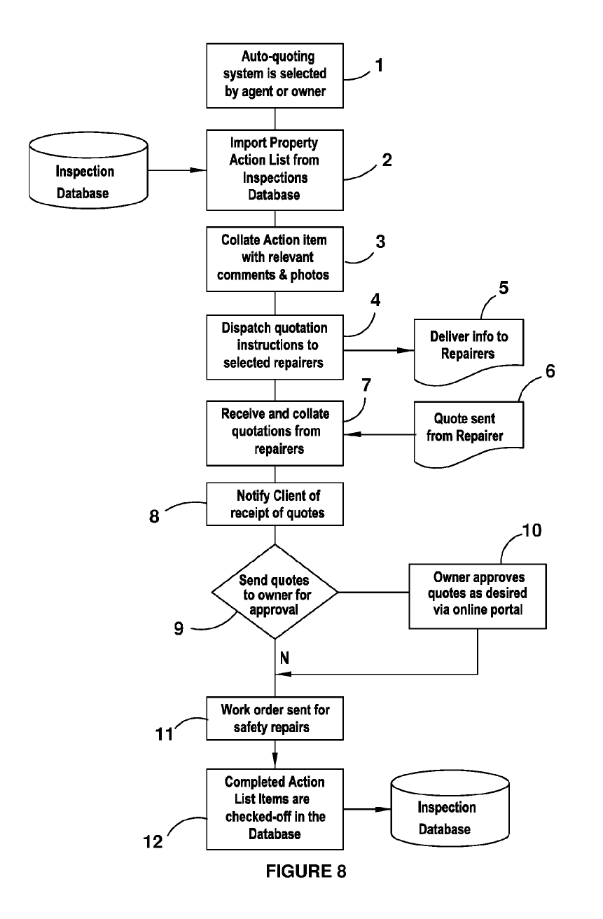

Referring to FIG. 8, more detail of a quotations module 230 functionality is shown in flow diagram form. Where the auto-quote system is selected (Step 1), then property action lists are downloaded from the inspection database (Step 2). The action item with relevant information, comments and photos from the report is then collated for all action items and dispatched to selected repairers with the appropriate skills (Steps 3, 4 and 5).

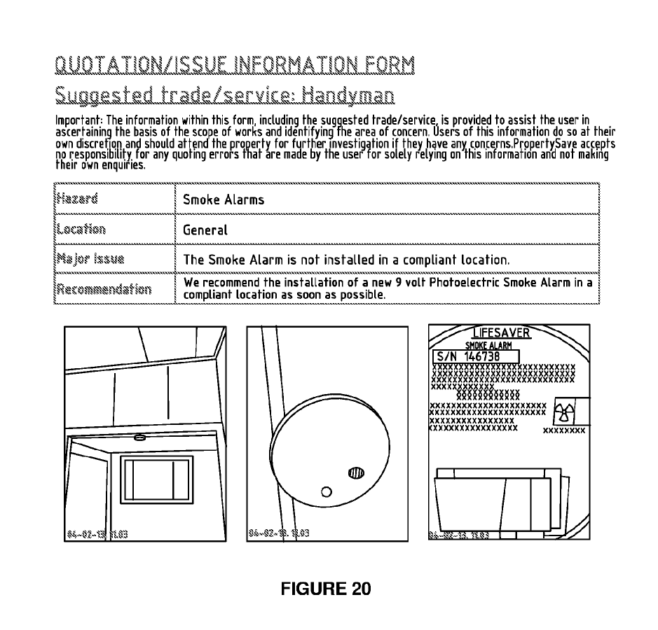

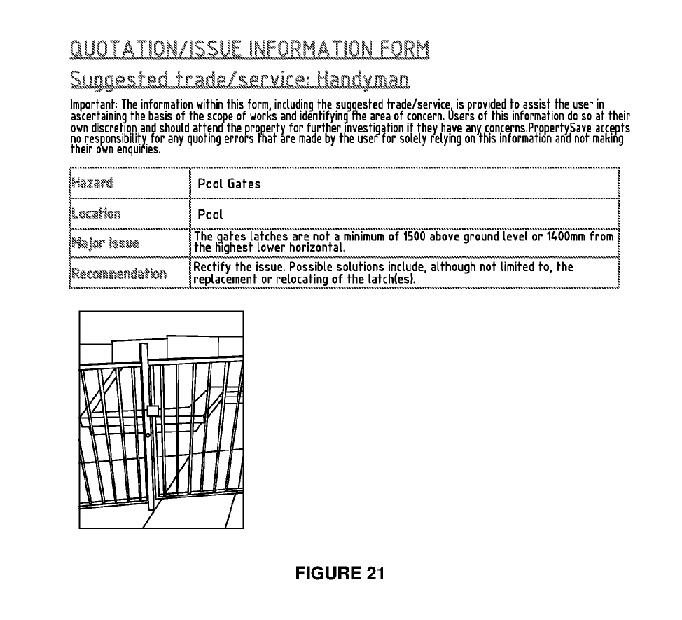

In an embodiment of the invention, the system 101 is arranged to issue a “quotation/issue information form”. In order to facilitate processing of the quotation forms, the system is arranged to issue a single quotation form for each issue. The maintenance issues can therefore be processed separately in this embodiment. Quotation issue forms for two issues are shown in FIGS. 20 and 21. The system can then send these quotation forms or information distilled from these quotation forms to the appropriate repairer (in this case to a Handyman and a Fence Expert). The information can be distilled into a format for use with the repairer App which is described below. The photographs may be sent to the repairer in the repairer App to facilitate a quote.

The repairers prepare their quotes and send them to the system (Steps 6 and 7). The customer is then notified via the system 101 of the receipt of the quotes and the quotes are sent for approval to the appropriate person e.g. property owner (Steps 8 and 9). The quote is approved via the online portal (Step 10). The system is then arranged to prepare an order for repair and send to the appropriate repairer (Step 11).

The system is updated as repairs are carried out and the database is updated (Step 12).

In an embodiment, repairers/tradesmen may be provided with a repairer process, which forms part of the system of this embodiment of the invention. The repairer process may be downloaded to a computing device of the repairer as a software “App”, or any other software or software/hardware combination. In one embodiment, the repairer process comprises an App which may be downloaded from the system 101 to either a computer of the repairer 106 or a mobile device 105 which may be a portable tablet or (more likely, with tradesmen) a smartphone. A smartphone/portable tablet has the appropriate hardware and software operating system to process and run the repairer App.

There are some current systems available which enable a repairer to enter quotes into a computer. These are usually quite complex computerised systems which require the repairer to fill in many fields. Often, tradesmen do not have the time or the computer skills to fill in complex computer forms. They therefore may not fill in the computer form or fill it in incorrectly.

The repairer process of the present embodiment facilitates a simple method by which the repairer may enter their standard quote according to their standard quote procedure.

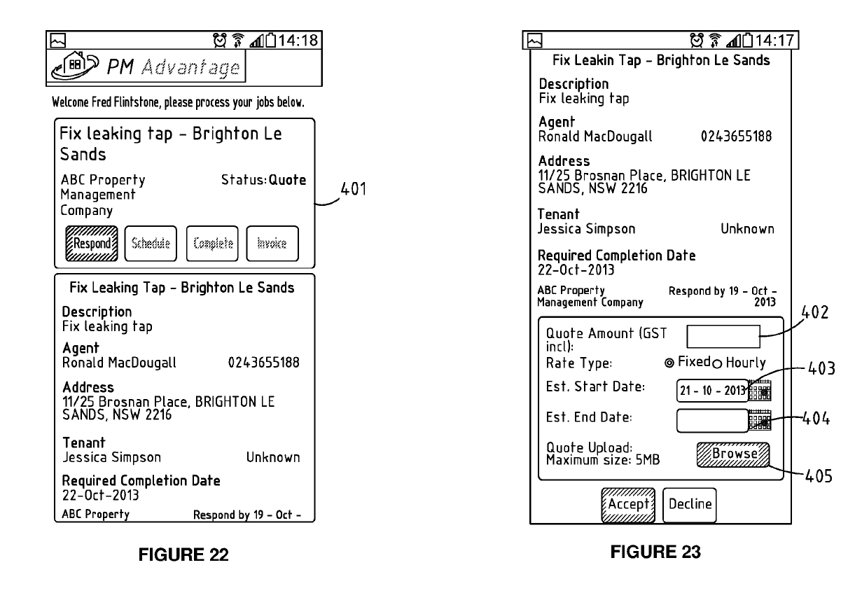

Referring to FIGS. 22 through 26, FIGS. 22 through 25 show screens which may appear on the smart phone of the repairer generated by the repairer process.

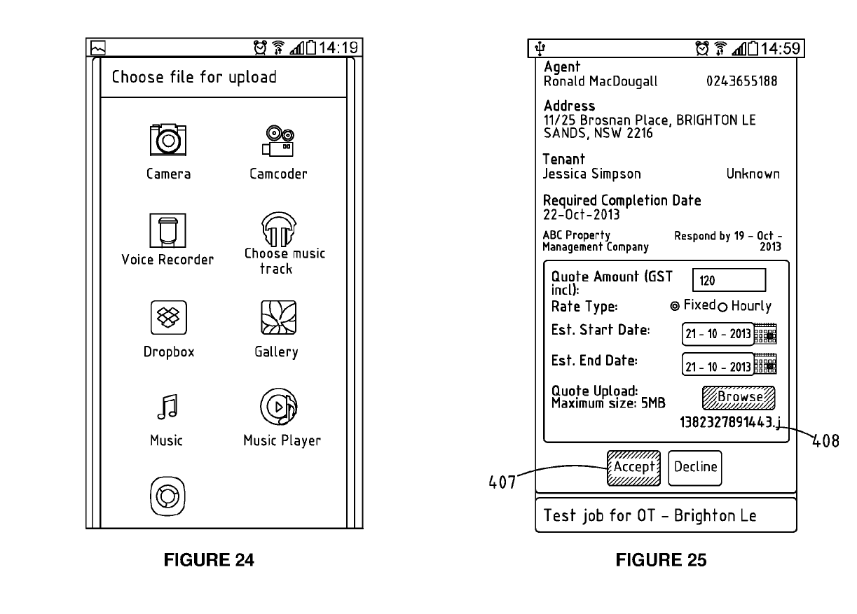

Screen 22 shows that the repairer receives a request to “fix leaking tap” 401. At FIG. 23, a screen is provided to the repairer which enables him to enter a simple quote amount (field 402 and a start date and end date 403, 404). A browse button 405 is also enabled which, if actuated, facilitates upload of a file to go with the quote to the property agent, via system 101. The screen in FIG. 24 enables the repairer to upload his desired file. In one example, it may merely be a photograph of his usual written quotation document. Other examples may be any other files which the repairer may find convenient to provide.

FIG. 25 shows that the repairer has uploaded a JPEG photograph (reference 406). On actuation of the accept button 407 the quote is transmitted back to the system 101.

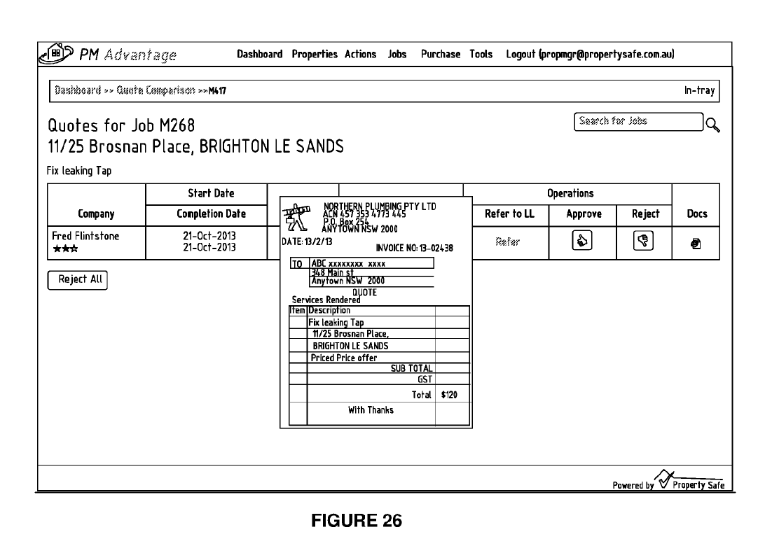

The property operative (e.g. agent) can then view the quote and any uploaded files on his computing device 108. Referring to FIG. 26 it can be seen that in this example the repairer has provided an image of his normal written quotation document, as well as filling in the simple fields provided by the repairer process interface.

The property operative can then send the quote for approval to the owner, for example. Once the quote is accepted the job can then be scheduled.

Note that the repairer process is not necessarily limited to operation with the system of this embodiment of the invention. The repairer process could be used separately from the system, to facilitate quoting by tradesmen.

The system 101 will capture a lot of data (in database 104) relating to maintenance and repair of properties in many geographical areas. In an embodiment, an analysis module 232 is able to undertake analytical processing of the data and generate information that will assist in better understanding and identifying health and safety risks involving residential properties. This information may be of benefit to many organisations, including banks, insurance groups, state or federal government bodies and more.

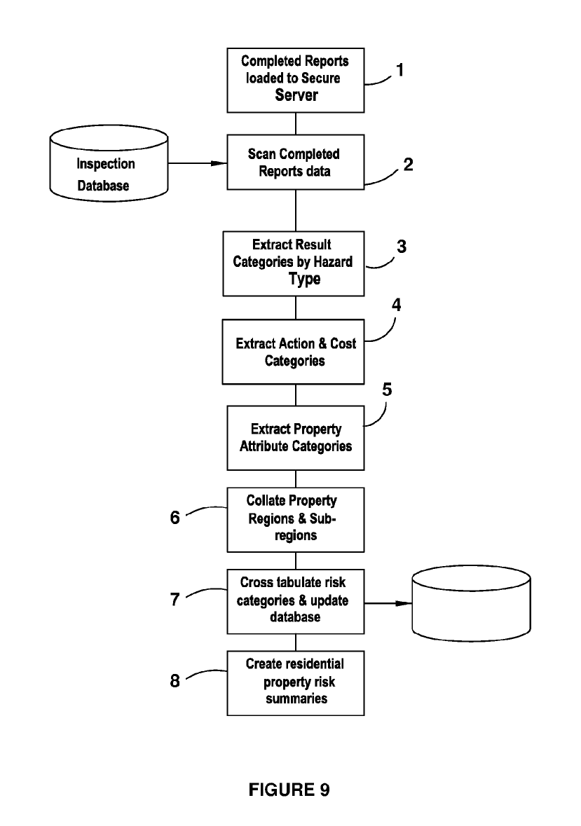

FIG. 9 is a flow diagram illustrating some functionality of an analysis module 232.

Reports and data are loaded to the database (Steps 1 and 2). Analysis can then be carried out by their various categories and attributes (Steps 3, 4, 5). This information is then collated geographically (Step 6) and then analysed to create residential property risk summaries for example (Steps 6, 7 and 8).

Other analysis can be undertaken, not just to provide risk summaries. Analysis could be made, for example, of by region cost of property maintenance. Any other analysis that use this data could be carried out.

The following example is a demonstration of how the system may be utilised, particularly by the property manager who, in this case, may be a real estate agent, for example.

### EXAMPLE

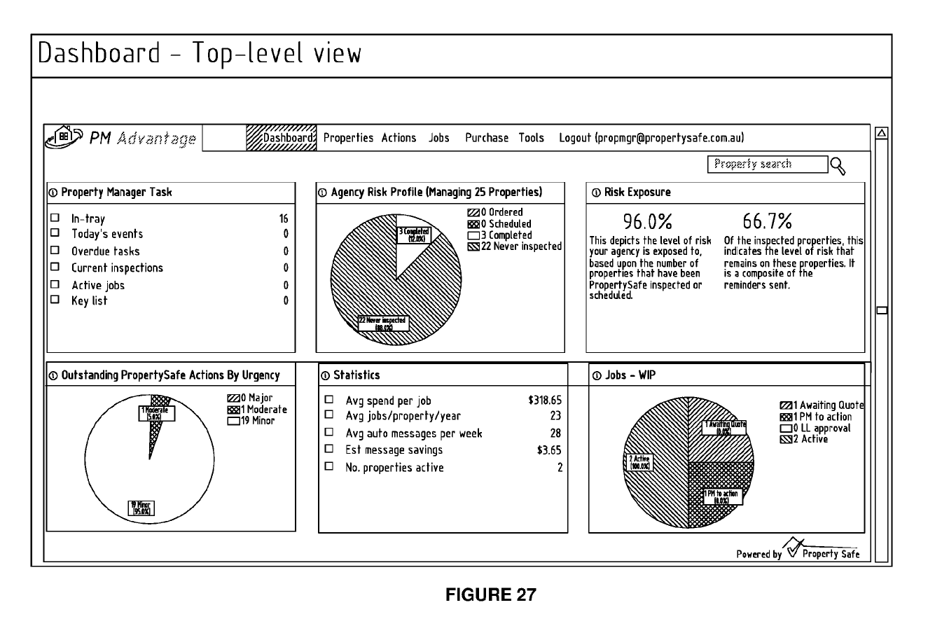

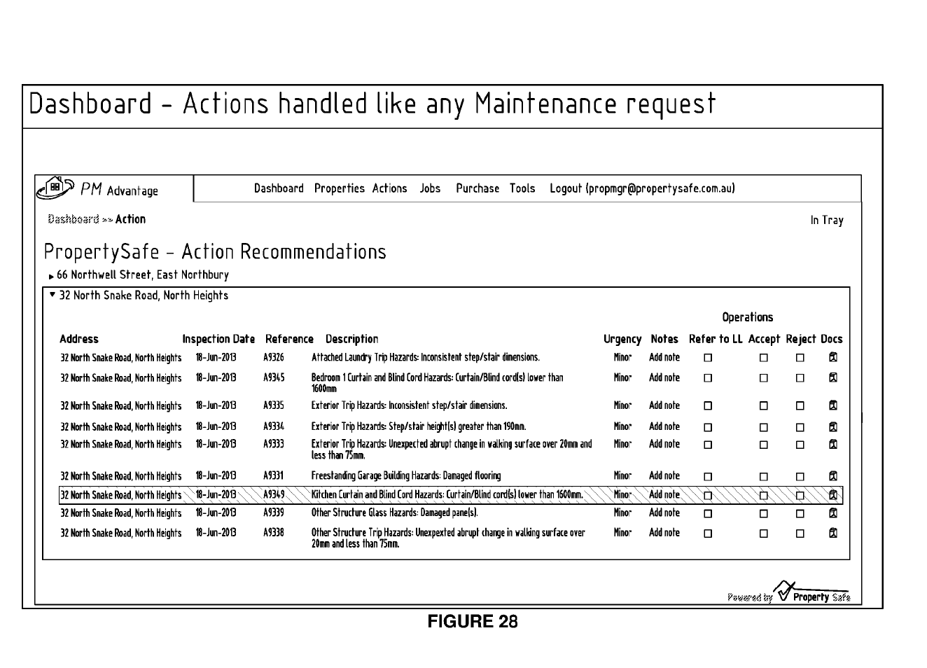

With reference to FIGS. 27 to 28, a demonstration of operation of an embodiment of the system will now be given as an example. Advantageously, this embodiment will save the property manager an immense amount of time and reduce their risk exposure (and the landlord's), over conventional property management systems.

The system automates correspondence to landlords, tenants and trades people, it automatically chases them for a response, it reminds them and the property manager about important tasks.

FIG. 27 shows the system Dashboard, where it can be seen in an instant what is going on and where the property manager (PM) will spend their time. Please note that terms such as “PM Advantage” are trade marks, and the system is not limited to such terminology. The pie charts and the percentage indicators show risk exposure.

However it is the Property Managers “Tasks” area that may be the immediate focus. The “In-tray” is designed to be similar to an e-mail Inbox e.g. Microsoft Outlook™, if it has a number beside it, the PM has tasks to address.

Tasks are broken down into key areas. The system operates as a complete maintenance module where jobs can be derived from two main areas, being the PropertySafe™ report or regular maintenance tasks identified by any of the normal means. Once an issue is identified it follows exactly the same process path throughout the system.

Looking at the PropertySafe™ Recommended Actions (FIG. 28), these are direct extractions from a PropertySafe™ report, allowing the PM to deal with each recommended action individually and expediently. The PM can look at an issue, view the documentation, and then either refer it to the landlord/owner, accept and address the issue or reject it via the system's “one” key functionality.

All maintenance requests are set up the same way, with the same familiar functionality.

The system can enable all of the following tasks to be done in a very short time:

initiate a job;

enter it into the system;

send it to the landlord/owner or any other approver for approval with the relevant supporting documents;

chase up approval;

receive back the advice from the approver;

send the job for quotes to three tradesmen/repairers with full documentation;

chase up those quotes;

receive, collate and compare the quotes;

send them, including the quotes documents again to the approver with recommendations for approval;

receive back an approval;

send out a work order to the selected repairer to get the job done;

advise the unsuccessful repairers;

check and approve the final invoice; and keep a detailed record of all associated correspondences to all parties.

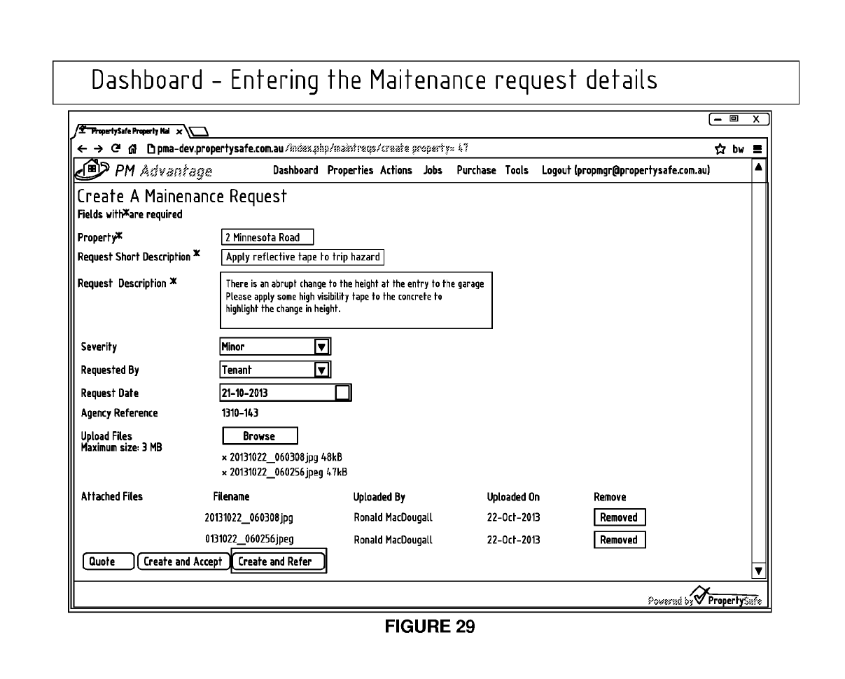

We start with creating the maintenance request (FIG. 29). The PM starts typing in the address and the property will come up for selection. The PM enters a short issue description, followed by a more detailed one if required. Remembering that this description is the one that will be used in all the automated correspondence that will generate landlord approvals and the tradesman quotes.

The PM selects the severity or urgency, which sets up expectations and is a factor in the system's automated job reminder system. Follow-ups and reminders are sent out at selected intervals depending on the job's urgency. The PM then selects where the request came from. In this case let's assume we have just had an e-mail from a tenant. We also have a photo we wish to attach, to assist with the approvals and quoting.

Finally, the PM has the choice whether to just create the request and deal with it later, create it and approve it now, or create it an instantly refer it onto the landlord/approver, which is what is shown in this case. The system confirms the selection.

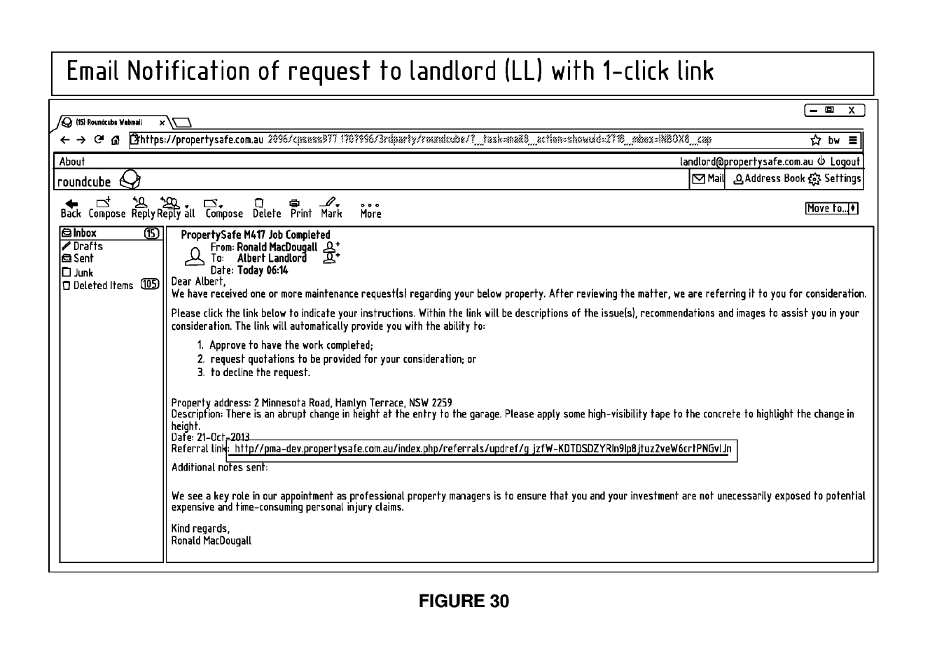

In this example, “Albert” is the landlord, and this (FIG. 30) is the e-mail Albert will receive from the property manager. The system sends it out as if it came directly from the PM. The email details the issue and contains an embedded link which Albert can merely click on to get the ability to see the full details and instantly respond. Note, the link opens without the need for any passwords.

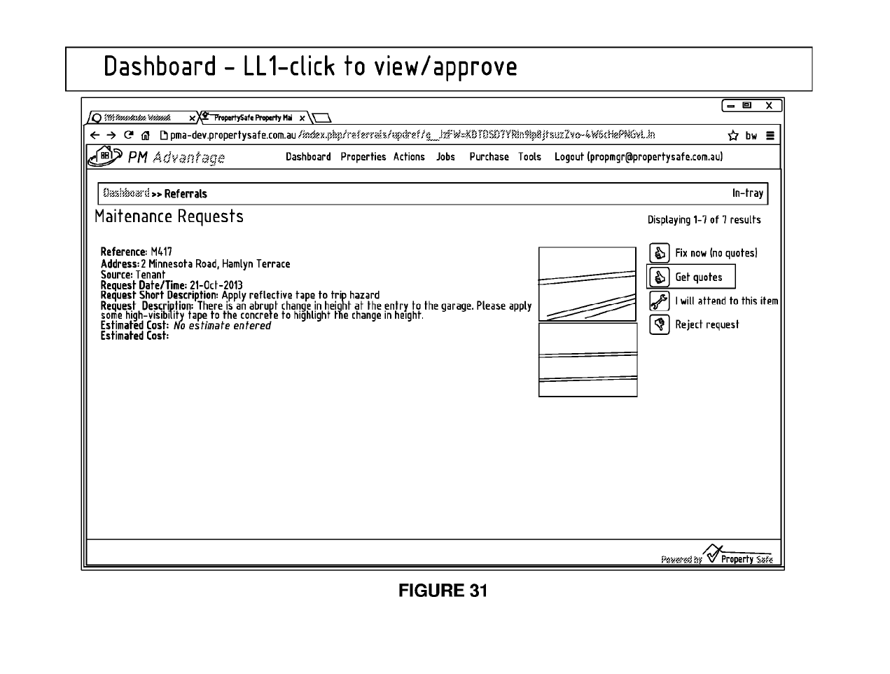

FIG. 31 shows the landlord link opened, you can see the details, the image and the options available to the landlord. Albert can approve it to be fixed immediately, request quotes, elect to rectify it himself, which will automatically generate caution letters reinforcing the need to use only qualified tradesmen plus trigger reminders in the system so that the matter is addressed. Many matters being attending by Landlord tend to go into “black holes” and, if landlords do not fix them, they can lead to major issues if a subsequent accident occurs, if so, the PM is still held liable if they do not follow up. This addresses that issue. Finally the landlord can elect to reject the request and will then have their reasons recorded and then retained in the event log.

In this example the landlord decides to request quotes.

The system, will then inform the PM of the landlord's decision and the system will instantly be updated.

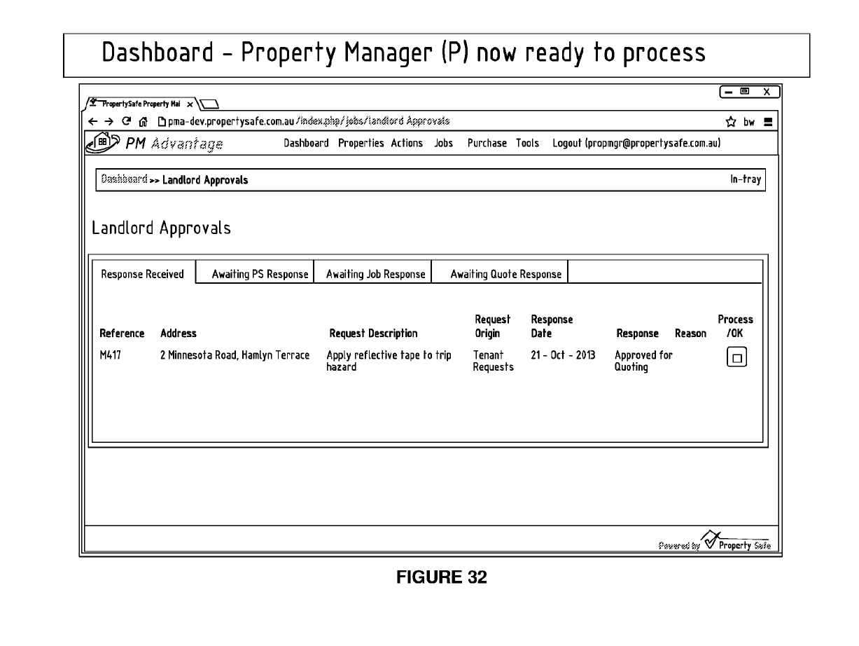

In the landlord approvals section (FIG. 32), we can see there is now 1 item to be addressed. All the PM needs to do is click on it to show it has been seen and allow processing to begin.

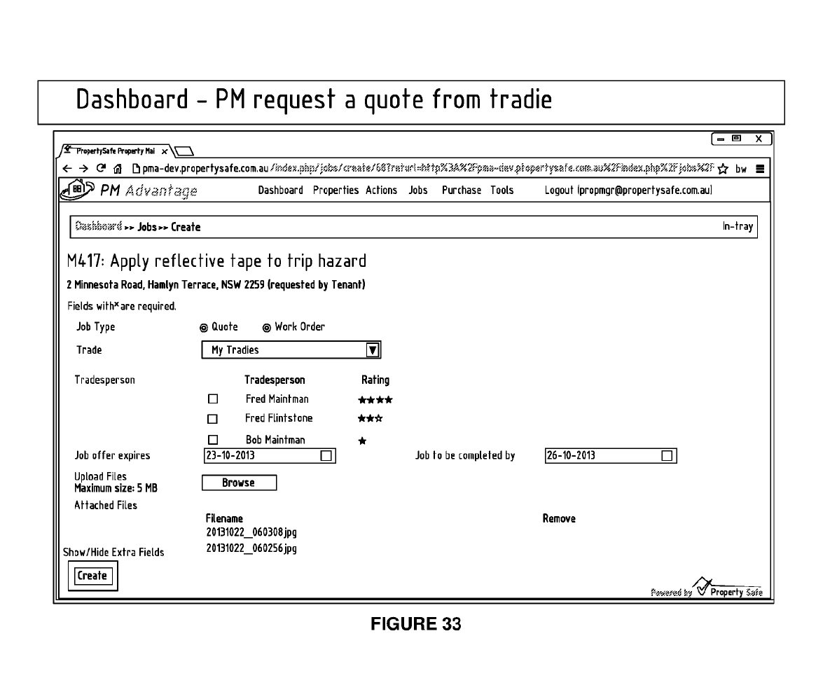

This takes us to the Allocation screen (FIG. 33), where we have the opportunity to select the repairers we wish to use for any ask. This example has been pre-selected as a quote due to the landlord's instructions.

The PM can elect to use their own repairers or use the “trade drop-down menu” to locate other real estate experienced repairers for each trade type. For this example job, we will send the quotes out to one repairer and select that we want the quotes back in two days. Note that the system allows for quotes to be sent to more than one repairer. Then the PM simple creates the request and sees the confirmation.

In the Quotes Comparison area, the quote is there waiting for the quotes to come back. The PM also gets a confirmation e-mail from the system, if desired.

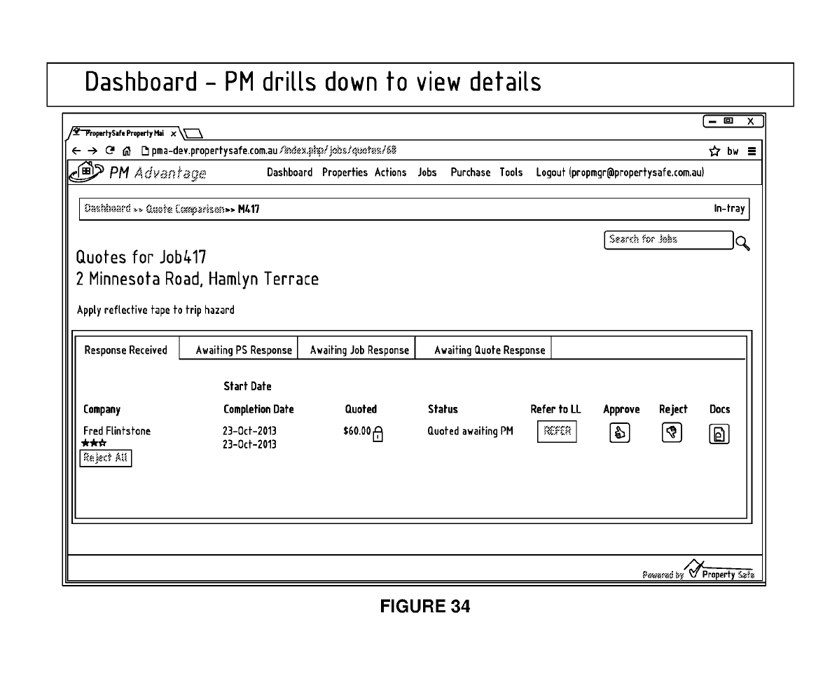

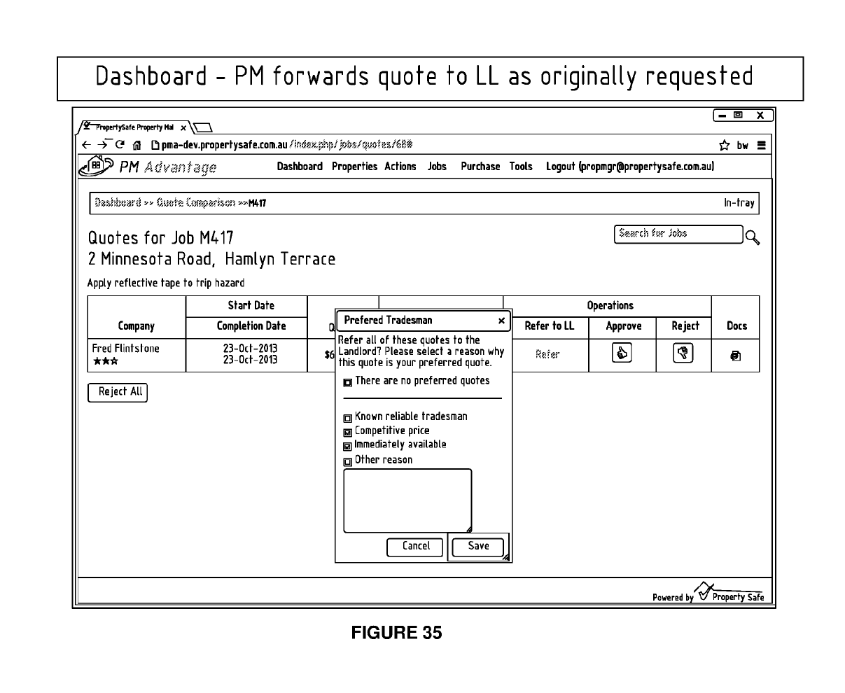

Now the quote is back (FIG. 34). The PM clicks into the item, they see the summary. The summary containers the repairer ID, the amount and projected start and finish dates from which decisions can be made. FIG. 35 shows selection of an individual quote, which the PM can accept or refer to the landlord for a decision. The PM in his case selects the quote. The PM clicks on “refer” and the system prompts as to why the last quote is preferred, (in this case it a competitive price and the repairer can do it immediately).

The job moves onto the “awaiting quote response” in the Landlord Approvals area.

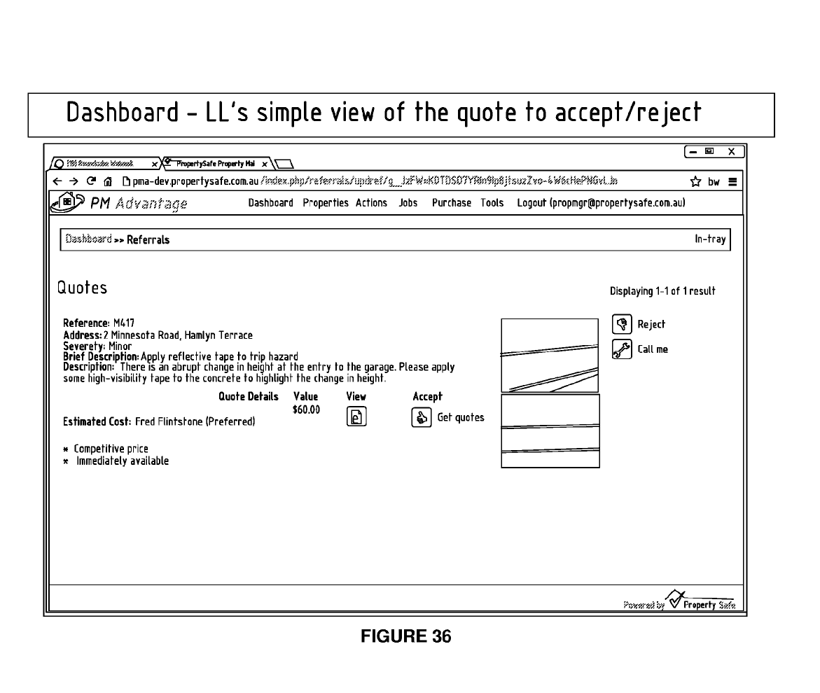

Albert, our landlord, receives the e-mail informing him of the quotes and seeking his decision. Again there is an embedded link, facilitating a quick and easy response. Immediately he can see the details of the quotes, what the PM's preferences are and why, she can open and examine any quotes and as such is now fully informed. His decisions are to approve a quote, reject the request or request that she be contacted (FIG. 36).

In this instance, Albert confirms the PM's recommendation and approves the job.

Back at the In-tray, Albert's approval has come through, so the PM can simply go in and process the decision. The repairer gets a confirmation e-mail. Albert also receives a confirmation e-mail to ensure that a record of his instructions are contained in the event log.

So now the job has progressed to being a “active” job. The repairer gets all their necessary information to their phone and e-mail, and are provided a simple user friendly system that they can access via their smart phone or computer system to quickly respond to the PM.

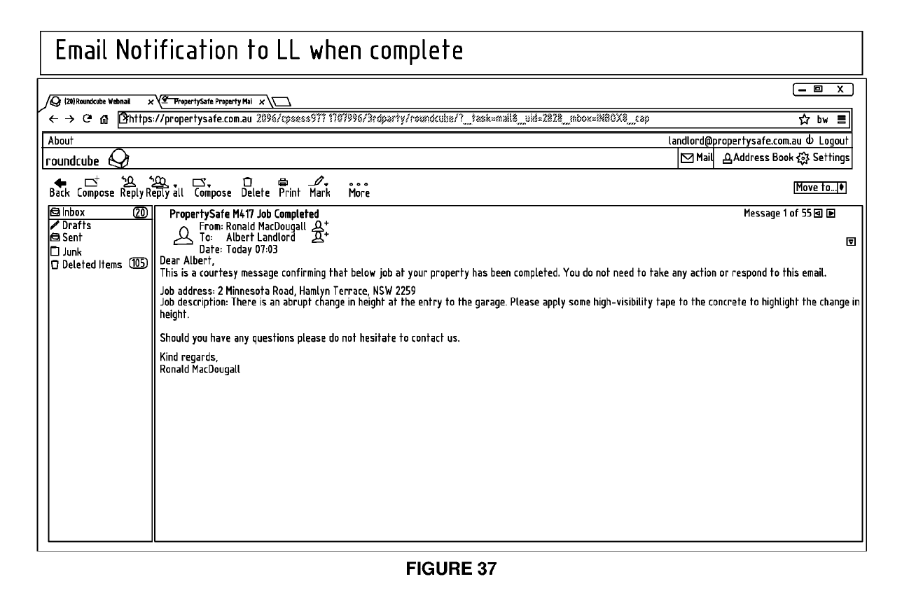

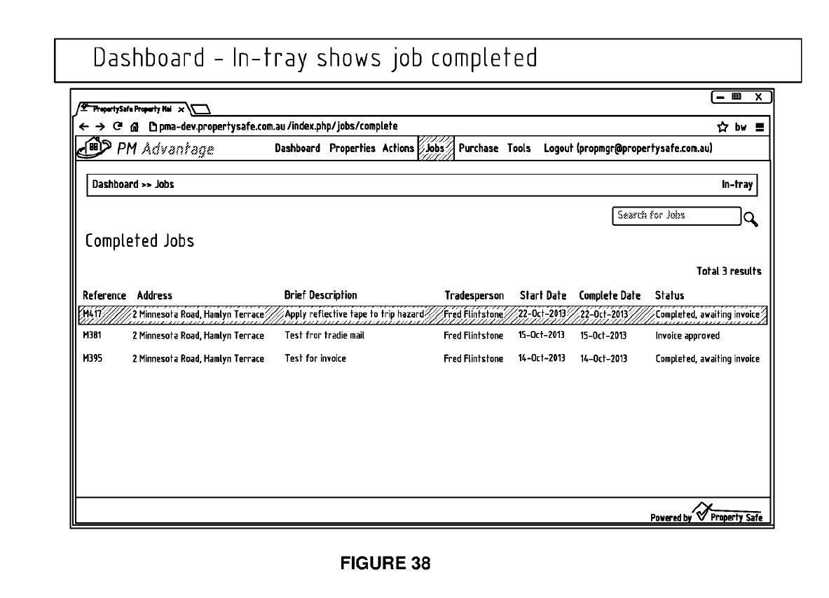

The repairer schedules the job and then completes it, with the system keeping the PM fully informed at every stage. FIG. 37 shows the completion advice to our landlord, Albert, we can look at the system and see it being shown up in the “completed jobs” list (FIG. 38).

The repairer submits his invoice via the system, with Albert being advised. The job now resides in the “Payment Approvals” area. Here the job is summarised. As it was originally a quote, it shows that there is no variation. It includes the invoice for review and allows the PM to approve or dispute the payment.

On approval of the payment, the system will send the PM a notification that the payment has been approved with a copy of the invoice so it can be simply entered into their trust system as a disbursement.

The system “Events Log” pertains to the risk laden area of maintenance. We can see all correspondence on a matter, including the full e-mails sent and received, actions and decision confirmations. It can be sand-alone or copied as a pdf back to a trust system. This system does not try and cover financial dealings regarding a property it merely covers anything regarding maintenance that may be required for any related court matter, for example.

Regarding the set-up, the tools area is where correspondence procedures can easily be established, who gets what and when. These can be changed for the system overall or per property. Likewise will all the correspondence templates. The system of this embodiment incorporates pre-prepared templates which will clearly save time. They are accessible and modifiable to suit the requirements of a particular PM.

Referring again to FIG. 1, in the above embodiment, maintenance issues may also be provided to the system 101 by maintenance issue logging apparatus 300. The maintenance issue logging apparatus 300 may be portable computing devices such as tablets or smart phones or any other computing device. A maintenance process, in this embodiment in the form of a maintenance application, is provided which enables a user of a device 300 to obtain maintenance information about a property maintenance issue and communicate the maintenance information to the system 101.

The maintenance information provided by the apparatus 300 may supplement information provided by the inspectors' apparatus 105 or may separately alert the system 101 of maintenance issues that arise without requiring a full inspection.

The user of a device 300 may be a property inspector, but more likely will be a relatively unskilled user, such as a tenant of the property, the real estate agent who is acting as a property manager, or even the owner of the property. It could be any one who notices a maintenance issue and wishes to report it.

Although the maintenance issue apparatus 300 may be used with the system 101, in an embodiment it may also be used separately to report maintenance issues to repairers or other property operatives generally, without use of the system 101.

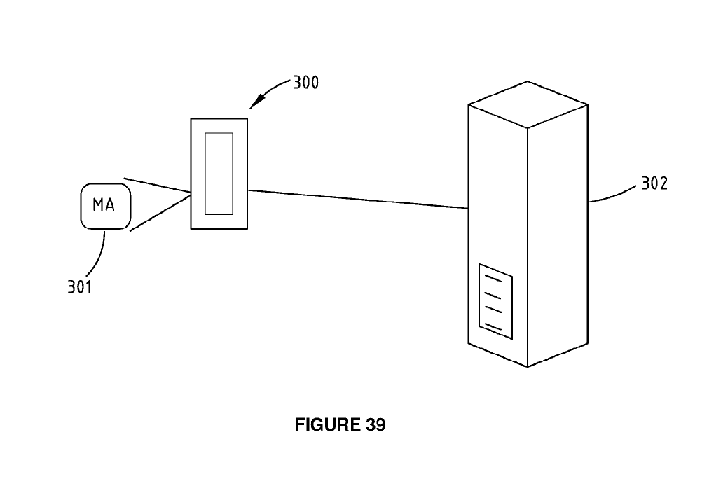

An embodiment of a maintenance issue logging apparatus will now be described in more detail with reference to FIGS. 39 to 42. FIG. 39 shows a maintenance logging apparatus 300 in the form of a smart phone, having downloaded a maintenance process in the form of a maintenance App (MA) 301.

The maintenance logging apparatus 300 is arranged to communicate with a computing device 302, in this embodiment being in the form of a server. It may communicate via any network, for example the Internet. The server 302 may, in an embodiment, be the computing system, 101 described above. Alternatively, it may be a separate server 302 for receiving reports on maintenance issues, independent of the system 101.

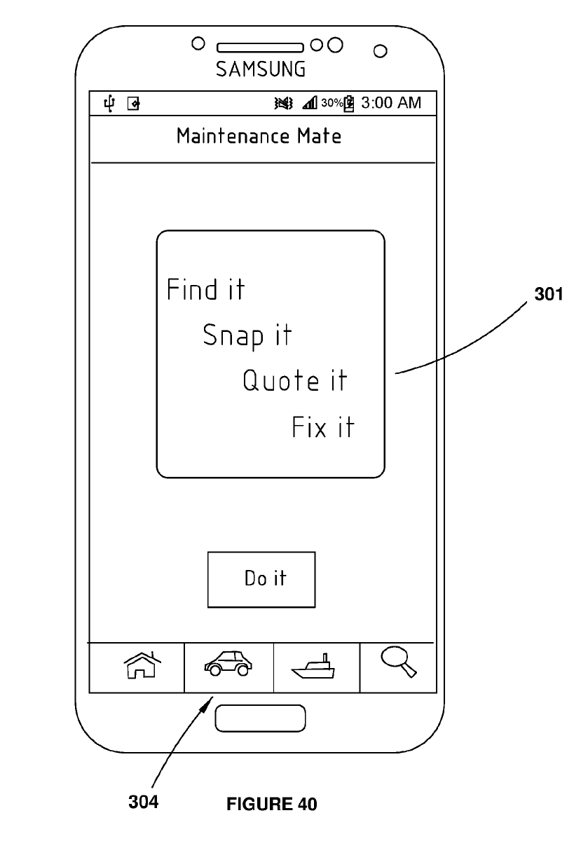

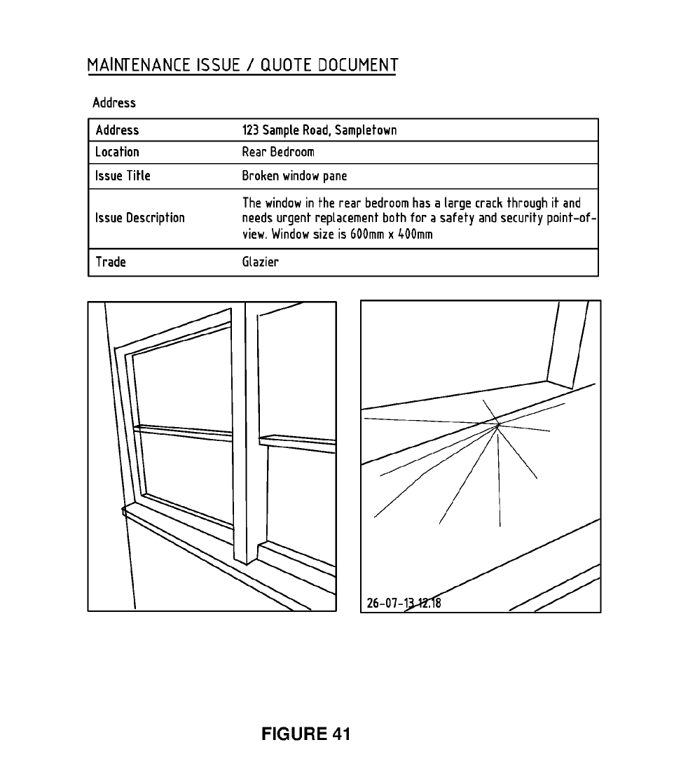

FIG. 40 shows a sample smart phone with the App 301 open, giving an example interface. Please note that this is an example only and the interface may vary. The functionality of the App is as follows. The maintenance process, once downloaded by the end user (as discussed above, they may be the tenant, owner, agent or anyone who may wish to report the maintenance issue) can select any of the following actions:
1. select what type of asset they are recording or reporting a maintenance issue on, e.g. house, unit, office, car, boat etc. In the embodiment shown in FIG. 40, there is an interface 304 which enables selection of the appropriate property asset. Depending on which asset is selected, different lists of questions are then generated by the App 301;
2. select, enter or record a “key issue title”—a simple short description of the issue which depending on what it is being used for, it may trigger automatic responses. For example for rental properties there is a drop-down of issues and depending upon which one is chosen the system links that to an urgency factor, and hence it will automatically inform more relevant parties, e.g. a leaking tap, is minor and would contact the property manager whereas a broken water pipe would contact the property manager and the agency principle. Contact is via the server 302 which may be administrated by a system administrator who may then forward the communication to the property operative involved (e.g. property manager). In another embodiment, the server 302 may be administered by the property manager or other property operative.
As discussed above, one of the features of this apparatus is that it can associate the maintenance issue with one of two or more available priority levels (“urgency factors”). The priority level allocated by the apparatus may be obtained directly from the type of maintenance issue or may be allocated by the user or the property operative receiving the maintenance issue. If auto-allocated or allocated by the end user, the priority level may cause the maintenance issue information to be sent to different property operatives. E.g. A very urgent issue may go directly to the top property manager and agency principal, or any other property operative who is required to address an urgent situation. The less urgent issue may require a lower priority level e.g. a maintenance issue that can be repaired non-urgently.
3. enter or record a detailed description and add photo(s); OR
4. video the issue and record a description;
5. SEND! Merely send the image and details to the predetermined location;
6. receive back as an e-mail a confirmation of what you sent and to whom.
The collected information is sent to the server 302 where it is collated and provided to the recipient in:
a summarised Maintenance/quote document, whereby all the images and descriptions are collated into one concise document that will facilitate easy and accurate quoting if required (see FIG. 41 which shows an example of such a document). This document will be sent onto identified trades people if selected can be delivered to an identified person, e.g. property manager, for distribution; or
the format that they require in the case where the user elected to send the information to a third party quote generating company or maintenance group, this may be via an API or some other methodology required.

The maintenance/quote document of FIG. 41 may be automatically generated by the apparatus 300 or may be generated by the server 302 or may be generated jointly by the server 302 and apparatus 300. Text may be incorporated in the quote document, as shown, and may be entered by the user or by the system based on the maintenance issue information received from the device 300. In some embodiments, the maintenance issue document may be sent directly to a repairer for a quote on repairing the maintenance issue.

Please note that in embodiments, the maintenance process may not be an App. In other embodiments, the device 300 may access a website (e.g. mobile website), or it may be any software/hardware arrangement.

### Set-Up of Maintenance Apparatus

Once the device 300 downloads the App/accesses the mobile website, a set of once-off set-up questions is applied, via access to the server 302, that collates all the required information for future use. This information is retained in the App/mobile website. The information required will vary depending upon the type of asset that may require maintenance.

### Example—Residential Property

The set-up of the App/mobile website will initially ascertain whether the user is a home-owner or tenant. Depending upon the response the system will drive different responses. In the rental market, for example, Agents may alert a tenant to the existence of this system and provide them with a version or direct them where to get it. They will also provide them with an identifier, e.g. a tenant number (or other identifier), which will be used by the system to identify the tenant.

The tenant will use this additional verification information (e.g. name, date of birth, or any other information) to confirm their identity and then the system will automatically configure the system so that it:

reflects the corporate design of the agency. The App may therefore be “branded” with the particular agency brand, (e.g. where the agency is a large well-known agency). Alternatively, the App may be separately branded from any of the providers such as the agencies;

downloads all the agent specific settings
agent name;
agent email;
agent phone number;
principal's e-mail;
agent connectivity protocols—i.e. who and how to contact etc.;
property address;
other agency desired information;

downloads tenant details
tenant name;
e-mail address;
phone number.

For the general home-owner the system will collect basic personal details:

name;

e-mail;

phone;

address.

In addition it will require the user to set-up basic correspondence settings, which is how the user will distribute the information that the device has collated. That is, if there is an issue that needs to be addressed, where is that information going to be sent? The user will have the opportunity to:

enter the contact details for their current trades people they use;

select which of the main quoting organisations that they want the information sent to, e.g. Service Seeking™, Quotify™, Service Central™ etc.;

general maintenance groups'

etc.

### Other Asset Groups

For the other asset groups the set-up questions will pertain specifically to them. For example: car or boat
make;
model;
year;
trades people pertaining to this asset.

### Third Party Connections

The system may establish links with all the main quoting and maintenance groups and will automatically forward on all the collated data pertaining to the maintenance issue so that they can immediately respond and commence providing the requested information. Each group will use their individual and established processes for providing this information and corresponding back directly with the client. A rating system may also be provided to ascertain what users think of the service.

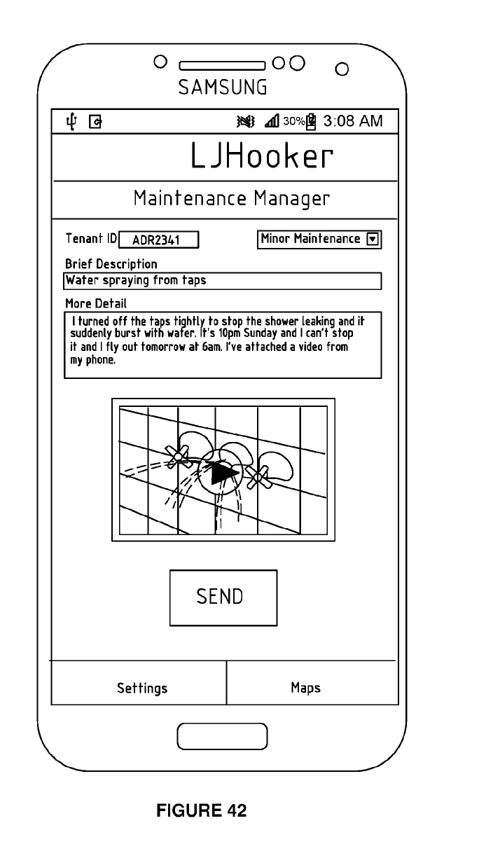

FIG. 42 shows a sample screenshot which may be generated by the device, in this case showing an example where the maintenance issue is an urgent maintenance issue which relates to water “water spraying from taps”.

This embodiment of the maintenance issue logging apparatus and system may significantly reduce the amount of time and effort it takes people with maintenance issues to identify people who can potentially assist them, establish how to get in contact with them, collate the appropriate information to describe the issues and then get it to them.

Alternatively, as discussed above, maintenance apparatus 300 may operate with the system 102 to facilitate the property report or to separately report and deal with isolated maintenance issues.

In the above embodiments, property reports are prepared on maintenance items (similar to the appended example). The invention is not limited to this. The system may lend itself to facilitating preparation of other reports, such as routine inspections (pest, electric, etc.) and vacation report (when a renter is leaving a property).

In an embodiment, the system may also comprise a module which scores the condition of a property (e.g. scoring it out of 10 or out of 100 or some other measure) so that a simple measure of property quality and maintenance condition can be provided that is easy to appreciate.

In the above embodiments, the computing architecture utilised is server/client architecture. The present invention is not limited to this, and in other embodiments different computer architectures may be used. For example, standalone computers, network computers, terminal/mainframe architecture or the system may be implemented by cloud-based architecture, or any other architecture.

In the above embodiments, functionality is implemented by software programming of hardware devices. The invention is not limited to this type of implementation. Any manner in which the system can implement the functionality described above is encompassed within the present application, including software, firmware, hardware or any other implementation.

Embodiments of the present invention may be implemented to operate with any form of communication network operating with any type of communication protocol. Generally, where the underlying communication network or communication protocol includes additional routines, functionalities, infrastructure or packet formats, the skilled person will appreciate that the implementation of embodiments described above may be modified or optimised for operation with these additional routines, functionalities, infrastructure or packet formats.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed is:

1. A system for facilitating maintenance of a property, comprising a processor arranged to receive customer orders for property inspection, to communicate with an inspector system and initiate property inspection, to receive inspection data from the inspection system, a report generator arranged to generate a report on maintenance and repair required for maintenance and repair of the property, including a list of repair items, a repairer interface arranged to receive a repair item and enabling a repairer to provide repair quote information, a customer interface enabling a customer to approve a quote, the system generating a repair order on quote approval and providing the repair order to the repairer interface, and a maintenance database arranged to be populated with repair status of repair items, the customer interface accessing the database to determine repair status of repair items.

2. A system in accordance with claim 1, further comprising a maintenance process arranged to be operated by a remote device, arranged to obtain maintenance information about a property maintenance issue, and communicate the maintenance issue to the system, the maintenance issue including a repair item.

3. A system in accordance with claim 2, wherein the maintenance information comprises an image of the maintenance issue captured by the maintenance process.

4. A system in accordance with claim 1, being arranged to generate requests for quote to be sent to the repairer interface, in accordance with repair items listed.

5. A system in accordance with claim 4, being arranged to automatically generate the requests for quote.

6. A system in accordance with claim 4, arranged to generate a separate request for quote for each repair item.

7. A system in accordance with claim 1, wherein the system is arranged to generate a repair order separately for each repair item.

8. A system in accordance with claim 1, wherein each repair item is associated with one of a plurality of priority levels.

9. A system in accordance with claim 1, comprising a reminder arrangement arranged to automatically remind a customer about outstanding repair items.

10. A system in accordance with claim 1, wherein the repairer process comprises an application enabling a repairer to upload a file, which may include quote data in a repairer chosen format.

11. A system in accordance with claim 1, wherein the database is arranged to store historical data relating to the history of maintenance and repair of the property.

12. A system in accordance with claim 1, wherein the inspector system comprises an inspector interface arranged to guide an inspector through an inspection process in accordance with a predetermined format, the inspector interface receiving inspection data in accordance with a predetermined format, and the report generator is arranged to generate the report in accordance with the predetermined format.

13. A system in accordance with claim 12, wherein the inspection interface includes a guide to hazard items to be inspected, and predetermined responses to enter into the interface.

14. A method for facilitating maintenance of a property, comprising the steps of receiving customer orders for property inspection, communicating the orders with inspector systems to initiate property inspection, receiving inspection data from the inspection system, generating a report on maintenance and repair required for maintenance and repair of the property, including a list of repair items, receiving repair quote information from a repairer interface, receiving quote approval from a customer interface, generating a repair order on quote approval and providing a repair order to a repairer interface, and populating a database with repair status of repair items, enabling access to the repair status by a customer interface in order for a customer to be able to determine repair status.

15. A system for facilitating maintenance of a property, comprising a processor arranged to receive a plurality of maintenance issues from a maintenance process, the maintenance issues including repair items, a repairer interface arranged to receive a repair item and enabling a repairer to provide repair quote information, a customer interface enabling a customer to approve a quote, the system generating a repair order on quote approval and providing a repair order to the repairer interface, and a maintenance database arranged to be populated with repair status of repair items, the customer interface accessing the database to determine repair status of repair items.

16. A method for facilitating maintenance of a property, comprising receiving a list of repair items from a maintenance process, receiving repair quote information from a repairer interface, receiving quote approval from a customer interface, generating a repair order on quote approval and providing a repair order to a repairer interface, and populating a database with repair status of repair items, enabling access to the repair status by a customer interface in order for a customer to be able to determine repair status.

17. A tangible computer readable medium storing instructions for controlling a computer to implement a system in accordance with claim 1.

18.-24. (canceled)
